(19) United States
(12) Patent Application Publication
(10) Pub. No.: US 2026/0272756 A1
(43) Pub. Date: Sep. 17, 2026

(54) WEARABLE THROAT MUSCLE TRAINING APPARATUS

(71) Applicant: MAJMAAH UNIVERSITY, Riyadh (SA)

(72) Inventor: Ibrahim M. ALARIFI, Riyadh (SA)

(73) Assignee: MAJMAAH UNIVERSITY, Riyadh (SA)

(21) Appl. No.: 19/673,732

(22) Filed: May 11, 2026

(51) Int. Cl. A61H 1/02

(52) U.S. Cl. CPC A61H 1/0296; A61H 2201/1611; A61H 2201/165

(57) ABSTRACT

The present disclosure relates to a wearable throat muscle training apparatus designed as a mechanically actuated device that provides controlled, repeatable resistance to cervical and throat muscles. The apparatus includes a collar body frame positioned around the anterior and lateral neck regions, supporting two symmetrically arranged resistance modules and a pivot-mounted mouthpiece arm assembly. Each resistance module contains a compression spring within a spring chamber, guided by a central rod and adjustable via a preload screw to set initial resistance. The mouthpiece arm is connected through a pivot joint and incorporates a force transmission rod that moves axially. This rod engages both resistance modules simultaneously through a bifurcated structure. When force is applied via the mouthpiece, rotational motion is converted into linear displacement, compressing the springs evenly. Upon release, the springs expand, restoring the system to its original position, enabling consistent, balanced throat muscle training.

### TECHNICAL FIELD OF THE INVENTION

The present disclosure relates generally to biomechanical training devices and, more particularly, to a structurally integrated wearable apparatus configured for controlled resistance-based strengthening of throat and cervical musculature through mechanically governed load transmission. The disclosure is directed toward a device-centric system incorporating rigid structural components, guided motion elements, and calibrated resistance assemblies configured to operate without reliance on abstract or non-physical implementations.

### BACKGROUND OF THE INVENTION

Strengthening of throat and cervical muscles is essential in various therapeutic, rehabilitative, and performance-enhancement applications, including speech therapy, dysphagia management, and athletic conditioning. Conventional devices often lack precise mechanical alignment, controlled resistance modulation, and synchronized bilateral loading, resulting in inefficient force transmission and inconsistent training outcomes. Existing solutions also fail to ensure repeatable mechanical motion paths and controlled spring compression dynamics, thereby limiting effectiveness and durability.

Accordingly, there exists a requirement for a structurally robust, wearable apparatus capable of delivering synchronized, adjustable, and mechanically constrained resistance through a defined load path aligned with anatomical motion, while maintaining structural integrity and repeatability of operation.

The development of devices for strengthening throat and cervical musculature has gained increasing importance in clinical rehabilitation, speech therapy, and performance conditioning due to the critical role played by the suprahyoid and infrahyoid muscle groups in swallowing, phonation, airway stabilization, and head-neck coordination. Weakness or dysfunction in these muscle groups is commonly associated with conditions such as dysphagia, neurological impairments, post-surgical recovery limitations, and age-related muscular degeneration. As a result, a range of therapeutic and training solutions has been introduced with the objective of restoring muscular strength, coordination, and endurance. However, the majority of existing approaches rely on manual exercises, elastic resistance mechanisms, or loosely constrained mechanical devices that lack precise force control, alignment stability, and repeatable motion characteristics, thereby limiting their effectiveness in delivering targeted and quantifiable training outcomes.

Conventional therapeutic techniques often involve manual resistance exercises administered by clinicians, where external force is applied to the chin or neck region to stimulate muscle contraction. While such approaches allow some degree of customization, they are inherently dependent on practitioner skill and consistency, resulting in variability in applied force magnitude, direction, and duration. This lack of repeatability makes it difficult to quantify progress or ensure uniform training across sessions. Additionally, manual interventions do not provide a structured mechanical feedback system capable of maintaining consistent resistance profiles over time. Patients performing self-administered exercises without supervision may also adopt incorrect postures or force directions, leading to inefficient muscle engagement or potential strain.

Elastic resistance-based devices, such as bands or flexible straps positioned around the head or neck, have also been utilized to provide opposing force during movement. These systems typically operate on the principle of elastic deformation, where resistance increases non-linearly with elongation of the elastic element. While such devices are lightweight and inexpensive, they suffer from several mechanical limitations. The resistance generated by elastic materials is highly dependent on material fatigue, temperature, and repeated usage cycles, leading to inconsistent performance over time. Moreover, elastic systems lack defined guiding structures, resulting in uncontrolled motion paths that may deviate from the intended anatomical axis of movement. This misalignment reduces the efficiency of force transfer to the targeted muscle groups and may introduce undesirable lateral or rotational forces.

Spring-based exercise devices have been introduced in certain contexts to provide more predictable resistance characteristics compared to elastic systems. However, many of these devices are not specifically designed for cervical or throat applications and therefore lack anatomical conformity and ergonomic integration with the user's neck structure. Existing spring-loaded mechanisms often employ single-axis compression systems that do not account for bilateral symmetry of cervical musculature. As a result, these devices may induce uneven loading conditions, leading to asymmetric muscle activation and reduced therapeutic effectiveness. Furthermore, prior spring-based devices frequently lack precise guiding elements, allowing for off-axis compression, spring buckling, or misalignment of internal components during operation.

Another category of existing solutions includes head-mounted or chin-supported exercise apparatuses that utilize external frames or harnesses to apply resistance. These systems often rely on gravity-based loading, weighted elements, or externally anchored resistance mechanisms. While such configurations can generate measurable resistance, they are generally bulky, cumbersome, and unsuitable for continuous or portable use. The reliance on external anchors or weights also introduces variability in resistance direction depending on user posture and orientation. Additionally, these devices typically do not provide a direct and continuous mechanical load path aligned with the internal anatomical structures of the throat, thereby reducing the efficiency of targeted muscle engagement.

Certain motorized or electronically assisted devices have been proposed to provide controlled resistance and feedback during therapy. These systems incorporate actuators, sensors, and control circuits to modulate resistance dynamically. Although such devices offer improved precision in force control, they introduce significant complexity in terms of power requirements, maintenance, and reliability. The presence of electronic components increases susceptibility to failure, particularly in environments involving repeated mechanical loading and exposure to moisture or biological contaminants. Moreover, the reliance on programmed control techniques may limit adaptability to individual user biomechanics unless extensive calibration is performed. The cost and operational complexity of such systems further restrict their accessibility for routine therapeutic use.

A critical limitation observed across many existing devices is the absence of a well-defined and constrained load transmission pathway. In numerous designs, the force applied by the user is transmitted through multiple intermediate linkages, flexible components, or pivoting structures that introduce energy losses and misalignment. This results in reduced efficiency of force transfer to the resistance elements and diminished correlation between applied effort and generated resistance. Additionally, the lack of synchronized bilateral actuation mechanisms in many devices prevents uniform engagement of muscle groups on both sides of the neck, which is essential for balanced muscular development and coordinated function.

Another drawback associated with prior systems is the inability to precisely adjust and maintain initial resistance conditions. While some devices provide adjustable resistance settings, these adjustments are often coarse, non-linear, or difficult to calibrate accurately. In elastic systems, resistance cannot be preloaded in a controlled manner, whereas in many spring-based systems, adjustment mechanisms are either absent or not aligned with the primary force axis. This limitation restricts the ability to tailor resistance levels to individual user requirements or to progressively increase training intensity in a controlled and measurable manner.

Ergonomic considerations also present challenges in existing solutions. Devices that do not conform to the anatomical contours of the cervical region may shift during use, leading to inconsistent alignment and reduced stability. Improper positioning of resistance elements relative to the neck can result in off-axis loading, discomfort, and reduced user compliance. Furthermore, the absence of rigid structural frameworks in many designs allows for deformation or displacement of components under load, further compromising alignment and repeatability.

Durability and long-term performance are additional concerns in prior art devices. Components such as elastic bands, flexible straps, and loosely constrained springs are prone to wear, fatigue, and degradation over repeated usage cycles. This not only affects resistance consistency but also raises safety concerns related to sudden failure or loss of tension. Devices lacking internal guiding structures may experience progressive misalignment of moving components, leading to increased friction, uneven wear, and eventual malfunction.

In summary, existing solutions for throat and cervical muscle training exhibit significant limitations in terms of force consistency, alignment precision, structural stability, resistance adjustability, and durability. The absence of a mechanically constrained and anatomically aligned system capable of delivering synchronized bilateral resistance through a continuous and direct load path has hindered the effectiveness of prior devices. These drawbacks highlight the need for a structurally integrated apparatus that incorporates guided motion elements, calibrated resistance mechanisms, and stable anatomical engagement to ensure efficient, repeatable, and controlled muscle training.

### SUMMARY OF THE INVENTION

The present disclosure provides a wearable throat muscle training apparatus comprising a collar body frame, bilateral resistance module assemblies, and a pivotally actuated mouthpiece arm assembly configured to translate user-applied oral force into controlled axial compression of spring elements. The apparatus is constructed entirely of mechanical and structural components arranged to ensure direct and uninterrupted load transmission along predefined axes, thereby enabling consistent and repeatable resistance-based muscle training.

The apparatus integrates dual spring-based resistance modules symmetrically arranged about a central axis, with a force transmission rod operatively coupled to a mouthpiece interface. Rotation of the mouthpiece arm assembly about a pivot joint generates linear displacement of the force transmission rod, which simultaneously actuates both resistance modules. The system ensures collinear force application, guided movement, and constrained displacement through a combination of central guide rods, reinforcement ribs, and alignment interfaces.

The primary object of the present invention is to provide a wearable throat muscle training apparatus configured as a structurally integrated mechanical device capable of delivering controlled resistance to cervical and throat musculature through a defined and repeatable load transmission path. The invention seeks to establish a direct mechanical linkage between a user-actuated interface and resistance-generating elements such that applied force is transmitted without interruption, misalignment, or energy loss, thereby ensuring efficient muscle engagement and consistent training performance.

Another object of the invention is to provide a collar-based support structure that maintains fixed spatial positioning relative to the anterior and lateral cervical region of a user, thereby ensuring stable alignment of all operative components during use. The invention aims to eliminate positional variability and unintended displacement by incorporating a rigid collar body frame that serves as a reference structure for mounting resistance modules and a pivot assembly, thereby enabling repeatable mechanical motion aligned with anatomical axes.

A further object of the invention is to provide dual resistance module assemblies arranged symmetrically about a central axis, wherein each resistance module includes a spring-based mechanism guided by a central rod and constrained within a housing to maintain concentric compression. The invention aims to achieve synchronized bilateral resistance such that both sides of the cervical musculature are engaged simultaneously under uniform loading conditions, while also allowing independent adjustment to enable controlled asymmetry where required for therapeutic applications.

Another object of the invention is to provide a force transmission mechanism comprising a guided rod structure constrained within an internal reinforcement framework, wherein the rod is configured to translate only along a predetermined longitudinal axis. The invention seeks to prevent lateral displacement, torsional deviation, and off-axis loading by incorporating guiding surfaces that maintain strict alignment between the force transmission rod and the resistance modules, thereby ensuring efficient and predictable transfer of mechanical energy.

An additional object of the invention is to provide a pivotally mounted mouthpiece arm assembly configured to convert rotational motion induced by user-applied oral force into linear displacement of the force transmission rod. The invention aims to utilize a fixed pivot axis and an offset geometry to generate lever-based mechanical advantage, thereby enabling controlled amplification and direction of force while maintaining alignment with the resistance modules.

Another object of the invention is to provide a bifurcated engagement interface at the proximal end of the force transmission rod, wherein the interface is configured to simultaneously engage upper spring seats of both resistance modules. The invention seeks to ensure that a single actuation input produces synchronized compression of multiple resistance elements, thereby enabling balanced muscle activation and eliminating the need for independent actuation mechanisms.

A further object of the invention is to provide an adjustable preload mechanism integrated within each resistance module, wherein a threaded adjustment element is configured to impose a predetermined initial compression on a corresponding spring. The invention aims to enable precise and incremental adjustment of resistance levels through direct mechanical displacement, thereby allowing customization of training intensity and progressive adaptation to user-specific requirements.

Another object of the invention is to provide internal limiting structures within the resistance modules that define bounded travel ranges for moving components, thereby preventing excessive compression, mechanical overloading, and structural failure. The invention seeks to enhance operational safety and durability by ensuring that spring deformation remains within controlled limits and that component interaction occurs within predefined mechanical constraints.

An additional object of the invention is to provide a detachable mouthpiece interface configured for placement within the oral cavity, wherein the interface is rigidly coupled to the force transmission rod to form a continuous and uninterrupted load path. The invention aims to ensure that user-applied force is transmitted directly into the mechanical system without reliance on flexible or intermediate elements that may introduce variability or loss of efficiency.

Another object of the invention is to ensure that all operative components of the apparatus are mechanically interconnected in a manner that maintains consistent alignment, minimizes wear, and supports repeated cycles of operation without degradation in performance. The invention seeks to provide a durable and reliable device suitable for long-term therapeutic and training applications.

A further object of the invention is to provide a compact, wearable configuration that allows the apparatus to be used without external supports, anchors, or auxiliary equipment, thereby enhancing portability and ease of use. The invention aims to integrate all functional components within a self-contained structure that can be worn by a user while maintaining full operational capability.

Another object of the invention is to provide a device that enables repeatable and quantifiable training by ensuring that displacement of the force transmission rod follows a consistent linear path and that resistance generated by the compression springs remains predictable across repeated cycles. The invention seeks to facilitate accurate monitoring of user performance and progression through consistent mechanical behavior.

An additional object of the invention is to provide a system in which expansion of the resistance elements upon release of applied force produces controlled return movement of the force transmission mechanism, thereby enabling cyclic operation without the need for external resetting mechanisms. The invention aims to ensure smooth and continuous operation through inherent mechanical recovery of the resistance elements.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a wearable throat muscle training apparatus in accordance with an embodiment of the invention;

FIG. 2 displays flow chart of a method of operating a wearable throat muscle training apparatus in accordance with an embodiment of the invention;

FIG. 3 illustrates a complete assembled configuration of the wearable throat muscle training apparatus in accordance with an embodiment of the invention;

FIG. 4 illustrates a side-view representation of the wearable throat muscle training apparatus in an operational position on a user;

FIG. 5 illustrates an exploded perspective view of the wearable throat muscle training apparatus in accordance with an embodiment of the invention;

FIG. 6 illustrates a sectional view of an individual resistance module assembly in accordance with an embodiment of the invention;

FIG. 7 illustrates a detailed sectional view of the preload adjustment mechanism integrated within the resistance module assembly in accordance with an embodiment of the invention;

FIG. 8 illustrates a cross-sectional view taken along section A-A of the pivot joint assembly in accordance with an embodiment of the invention.

FIG. 9 illustrates a perspective view of the wearable throat muscle training apparatus in accordance with an embodiment of the invention;

FIG. 10 illustrates a perspective cutaway view of a resistance module assembly in accordance with an embodiment of the invention.

FIG. 11 illustrates an exploded, component-level view of the internal elements of a resistance module assembly in accordance with an embodiment of the invention; and

FIG. 12 illustrates an exploded perspective view of an electronic control and interface module integrated within the wearable throat muscle training apparatus in accordance with an embodiment of the invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

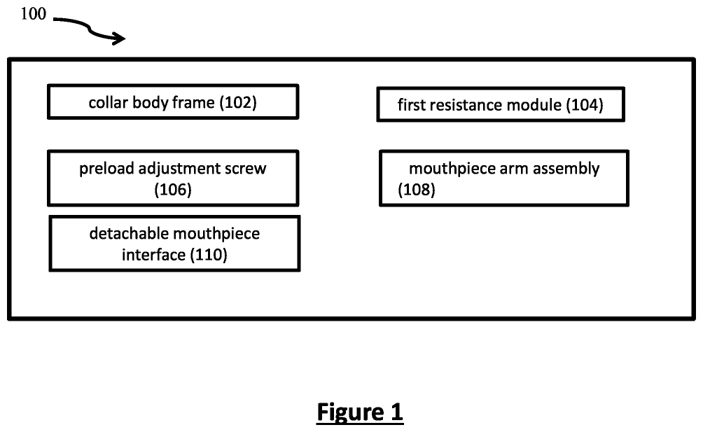

Referring to FIG. 1, a block diagram of a wearable throat muscle training apparatus is illustrated. The system 100 comprising: a collar body frame (102) configured to circumferentially engage an anterior and lateral cervical region of a user, the collar body frame including bilateral mounting openings positioned symmetrically about a vertical midline and a front central mounting bracket, the bilateral mounting openings defining fixed attachment interfaces maintaining positional alignment relative to the collar body frame; a first resistance module (104) assembly secured within a first mounting opening and a second resistance module assembly secured within a second mounting opening, each resistance module assembly comprising: an outer housing fixed to the collar body frame; a spring chamber cavity defined within the outer housing along a longitudinal axis; a compression spring positioned within the spring chamber cavity; a central guide rod extending through the compression spring and through aligned central bores of an upper spring seat and a lower spring seat, the central guide rod being retained within the outer housing by engagement between a retaining head and an internal alignment shoulder positioned within the spring chamber cavity; the upper spring seat and the lower spring seat being configured to translate along the central guide rod while maintaining planar contact with opposite ends of the compression spring; a preload adjustment screw (106) threadedly engaged with a threaded interface of the outer housing and aligned coaxially with the central guide rod, the preload adjustment screw including a distal contact surface positioned to engage a central region of the upper spring seat to impose an initial compression state of the compression spring; a mouthpiece arm assembly (108) coupled to the front central mounting bracket through a pivot joint including a pivot interface block and a pivot pin extending through aligned bores and defining a transverse rotational axis fixed relative to the collar body frame; the mouthpiece arm assembly comprising: an outer arm housing; an internal reinforcement rib extending longitudinally within the outer arm housing and defining guiding surfaces; a force transmission rod extending longitudinally within the outer arm housing and constrained by the guiding surfaces to permit axial movement while restricting lateral and rotational displacement, the force transmission rod including a bifurcated proximal engagement portion having two engagement arms positioned in direct abutment with the upper spring seats of the first resistance module assembly and the second resistance module assembly; a detachable mouthpiece interface (110) fixed to a distal end of the mouthpiece arm assembly and rigidly connected to the force transmission rod; wherein force applied at the detachable mouthpiece interface produces rotation of the mouthpiece arm assembly about the pivot pin, the rotation generating a moment about the pivot pin and producing axial displacement of the force transmission rod along a longitudinal axis offset from the pivot pin; wherein the axial displacement of the force transmission rod is transmitted simultaneously through the bifurcated proximal engagement portion to the upper spring seats of the first resistance module assembly and the second resistance module assembly to compress the compression springs along the central guide rods within the spring chamber cavities; and wherein expansion of the compression springs upon release of the applied force produces return displacement of the force transmission rod toward an initial position defined by the preload adjustment screws.

In an embodiment, each engagement arm of the bifurcated proximal engagement portion includes a planar contact interface oriented perpendicular to the longitudinal axis of the corresponding central guide rod, the planar contact interface maintaining continuous surface contact with the upper spring seat throughout compression and return movement while the bifurcated proximal engagement portion defines a fixed lateral spacing corresponding to spacing between the first resistance module assembly and the second resistance module assembly to maintain synchronous displacement of both upper spring seats.

In this embodiment, the geometry and orientation of each engagement arm are configured to ensure that force transfer into the resistance modules occurs in a strictly axial and uniformly distributed manner, thereby eliminating localized stress concentrations and misalignment during operation. The planar contact interface of each engagement arm is manufactured with a flatness tolerance sufficient to maintain full-surface engagement with the corresponding upper spring seat, such that when axial displacement is initiated, the contact is not limited to a point or edge but is distributed across a defined area. This configuration ensures that the compressive load is introduced centrally into the upper spring seat, which in turn transmits the load evenly to the compression spring along the central guide rod. In a practical implementation, the planar interface may be formed as a hardened metallic or reinforced polymer surface with a smooth finish, thereby minimizing frictional resistance and wear during repeated engagement cycles.

The perpendicular orientation of the planar contact interface relative to the longitudinal axis of the central guide rod ensures that the applied force vector remains collinear with the axis of spring compression. This prevents generation of bending moments or lateral forces that could otherwise cause tilting of the upper spring seat or uneven compression of the spring coils. For example, during high-frequency actuation cycles, such as continuous training repetitions, the perpendicular interface ensures that the upper spring seat translates without angular deviation, thereby preserving the structural integrity of both the spring and the guide rod interface. The maintenance of this orthogonal relationship is critical in preventing cumulative misalignment, which in conventional systems often leads to increased friction, noise, and eventual component degradation.

The bifurcated proximal engagement portion is dimensioned with a fixed lateral spacing that precisely corresponds to the spacing between the first and second resistance module assemblies as defined by the collar body frame. This fixed spacing is established during fabrication and does not vary during operation, thereby ensuring that both engagement arms simultaneously contact their respective upper spring seats at all times. In an exemplary configuration, the lateral spacing may be set with a tolerance matching the mounting geometry of the collar body frame, such that any axial movement of the force transmission rod results in equal displacement being imparted to both spring seats. This eliminates asynchronous compression, where one spring could otherwise engage before the other, leading to imbalanced resistance.

During operation, when the user applies force through the mouthpiece interface, the resulting axial displacement of the force transmission rod causes both engagement arms to advance simultaneously toward the resistance modules. Due to the fixed lateral spacing and planar interface alignment, both upper spring seats begin translating along their respective guide rods at the same instant, and the compression of both springs progresses in parallel. This synchronized displacement ensures that the resistance experienced by the user is evenly distributed across both sides of the apparatus, thereby promoting balanced activation of bilateral muscle groups. For instance, in a rehabilitation scenario where symmetric muscle strengthening is required, this configuration ensures that neither side is subjected to greater or lesser resistance due to mechanical lag or misalignment.

Furthermore, during the return phase, when the compression springs expand, the engagement arms maintain continuous surface contact with the upper spring seats without disengagement or loss of alignment. This continuous engagement ensures that the force transmission rod is driven back along the same linear path, maintaining consistency in motion across successive cycles. The absence of intermittent contact or separation prevents impact loading or sudden force variations, thereby contributing to smooth and controlled operation.

By maintaining continuous planar contact, perpendicular alignment, and fixed lateral spacing, this embodiment ensures that the force applied by the user is transmitted into both resistance modules in a synchronized and collinearly aligned manner. This results in uniform compression behavior, reduced mechanical wear, and enhanced repeatability of motion, enabling precise and reliable operation of the apparatus across extended usage cycles.

In an embodiment, the central guide rod of each resistance module assembly extends through the upper spring seat and the lower spring seat and is retained between the retaining head and the internal alignment shoulder such that axial movement of the central guide rod is limited prior to coil-to-coil contact of the compression spring, and wherein the central guide rod maintains concentric alignment of the compression spring within the spring chamber cavity during repeated compression cycles.

In this embodiment, the central guide rod is configured as a primary alignment and motion-limiting element that governs both the positional stability of the compression spring and the permissible range of axial displacement during operation. The guide rod extends continuously through the central bores of the upper spring seat and the lower spring seat, thereby establishing a common axis along which both seats translate. The dimensional relationship between the outer diameter of the guide rod and the inner diameter of the central bores is selected to achieve a close sliding fit, such that axial motion is permitted while lateral play is minimized. In a practical configuration, the clearance may be maintained within a controlled tolerance band to ensure smooth translation without binding, even under repeated load cycles.

The retention of the central guide rod between the retaining head and the internal alignment shoulder defines a mechanically bounded travel range that is independent of the spring's theoretical maximum compression length. The retaining head, formed at one end of the guide rod, is dimensioned to engage the internal alignment shoulder within the outer housing when a predefined axial displacement is reached. This engagement occurs before the compression spring reaches a coil-to-coil contact condition, thereby preventing coil stacking. For example, if the free length of the compression spring allows a maximum compression of 10 mm before adjacent coils come into contact, the spacing between the retaining head and the internal alignment shoulder may be configured to permit only 8 mm of axial travel. This ensures that the spring operates strictly within its elastic deformation range, avoiding plastic deformation or permanent set.

During operation, when the force transmission rod applies compressive force to the upper spring seat, both the upper and lower spring seats translate along the central guide rod while maintaining their orientation perpendicular to the rod axis. The guide rod acts as a rigid constraint that prevents tilting or angular displacement of the spring seats, thereby ensuring that the compression spring is compressed uniformly along its longitudinal axis. This is particularly significant during high-frequency or repetitive actuation cycles, where even minor misalignment in conventional systems can accumulate into significant deviations, leading to uneven stress distribution across the spring coils.

The concentric alignment provided by the central guide rod ensures that each coil of the compression spring deforms symmetrically around the rod axis. In practical terms, this eliminates the risk of lateral buckling, which is commonly observed in unguided or loosely guided spring systems. For instance, during extended training sessions involving hundreds of compression cycles, the presence of the guide rod maintains the spring in a stable configuration, thereby preserving consistent resistance characteristics and preventing irregular force response.

Additionally, the interaction between the retaining head and the internal alignment shoulder serves as a protective mechanism for the assembly. When the maximum permissible displacement is reached, the engagement between these components provides a definitive mechanical stop that absorbs further applied force without transmitting excessive load to the spring. This ensures that the structural integrity of the spring and associated components is preserved even under conditions of high user-applied force. The controlled limitation of axial movement also contributes to predictable system behavior, as the displacement range remains fixed and repeatable across all operational cycles.

The continuous guidance provided by the central guide rod further reduces frictional losses within the spring chamber cavity by preventing unintended contact between the spring coils and the inner walls of the housing. This results in smoother compression and decompression cycles, reducing wear and extending the service life of the apparatus. Over prolonged usage, such as daily therapeutic sessions over several months, the maintained alignment ensures that the mechanical response of the system remains consistent, thereby supporting reliable and reproducible training performance.

Through the integration of the central guide rod as both an alignment constraint and a travel-limiting element, this embodiment ensures that the compression spring operates within a controlled and stable mechanical environment, enabling uniform force distribution, prevention of structural deformation, and sustained operational consistency across repeated cycles.

In an embodiment, the preload adjustment screw (106) includes a threaded shaft and the distal contact surface aligned with the central guide rod, rotation of the preload adjustment screw producing linear translation of the distal contact surface along the longitudinal axis to vary a gap between the distal contact surface and the upper spring seat in a pre-load state and to impose a predetermined compressive displacement on the compression spring.

In this embodiment, the preload adjustment screw operates as a precision-controlled mechanical actuator that establishes the initial resistance condition of each resistance module by directly influencing the position of the upper spring seat along the central guide rod. The threaded shaft of the preload adjustment screw is engaged with a correspondingly machined threaded interface within the outer housing, such that rotational input applied to the screw is converted into linear displacement along the longitudinal axis. The thread geometry, including pitch and lead, is selected to provide fine resolution of adjustment, enabling incremental variation in the axial position of the distal contact surface with each rotation. For instance, a fine thread pitch allows small angular rotations of the screw to produce correspondingly small linear displacements, thereby enabling precise calibration of the preload condition.

The distal contact surface of the preload adjustment screw is aligned coaxially with the central guide rod, ensuring that any force imparted to the upper spring seat is directed along the same axis as the compression spring. This coaxial alignment prevents introduction of lateral components of force that could otherwise cause tilting or uneven loading of the spring seat. In a practical configuration, the distal contact surface may be formed with a flat or slightly contoured interface designed to mate with a central region of the upper spring seat, thereby distributing the applied load evenly and maintaining stable contact during adjustment.

During the pre-load state, a defined gap may exist between the distal contact surface and the upper spring seat when the screw is in an initial retracted position. As the preload adjustment screw is rotated in an advancing direction, the distal contact surface translates linearly toward the upper spring seat until contact is established. Continued rotation beyond this point produces a controlled displacement of the upper spring seat along the central guide rod, thereby compressing the spring by a predetermined amount. This initial compression establishes a baseline resistance that must be overcome before further displacement occurs during user actuation.

By controlling the magnitude of this initial compression, the apparatus allows customization of resistance levels according to user requirements. For example, in an early-stage rehabilitation scenario, the preload adjustment screw may be set such that minimal initial compression is applied, resulting in a lower resistance threshold. As the user progresses, additional rotations of the preload adjustment screw increase the initial compression of the spring, thereby raising the resistance encountered during operation. Because the displacement introduced by each rotation is directly determined by the thread pitch, the relationship between rotational input and resistance adjustment remains predictable and repeatable.

The linear translation of the distal contact surface also ensures that the adjustment process does not introduce any discontinuities or sudden changes in the mechanical response of the system. The compression spring transitions smoothly from its preloaded state to further compression during actuation, maintaining a continuous force-displacement relationship. This continuity is essential for ensuring that the user experiences a stable and progressive resistance profile, which is particularly important in therapeutic applications where abrupt force variations may lead to discomfort or improper muscle engagement.

Furthermore, the direct interaction between the preload adjustment screw and the upper spring seat eliminates the need for intermediate linkage components, thereby reducing mechanical complexity and minimizing potential sources of misalignment or wear. The alignment of the threaded shaft, distal contact surface, and central guide rod along a common axis ensures that the imposed preload is uniformly distributed across the spring, preserving concentric deformation and preventing localized stress concentrations.

In repeated usage scenarios, the threaded engagement maintains its positional setting due to the inherent friction between mating threads, thereby ensuring that the selected preload condition remains stable over multiple actuation cycles. This stability allows the apparatus to deliver consistent resistance characteristics without requiring frequent recalibration. Additionally, the ability to vary the gap between the distal contact surface and the upper spring seat provides flexibility in defining the initial engagement point of the spring, enabling tailored resistance profiles suited to different training protocols.

Through the integration of the threaded preload adjustment screw as a linear displacement mechanism aligned with the central guide rod, this embodiment enables precise, stable, and repeatable control over the initial compression state of the spring, thereby enhancing the adaptability and consistency of the apparatus during operation.

In an embodiment, the preload adjustment screw (106) of the first resistance module assembly and the preload adjustment screw of the second resistance module assembly are independently rotatable to establish distinct initial compression states such that displacement of the force transmission rod produces asymmetric compression responses of the compression springs, and wherein the pivot pin is oriented perpendicular to a plane defined by the bifurcated proximal engagement portion and is fixed relative to the collar body frame, and wherein the pivot interface block is fixed relative to the mouthpiece arm assembly such that rotation is confined to the mouthpiece arm assembly about the pivot pin.

In this embodiment, the independent rotatability of the preload adjustment screws associated with the first and second resistance module assemblies enables selective differentiation in the initial compression state of each compression spring, thereby allowing the apparatus to generate non-uniform resistance responses under a single actuation input. Each preload adjustment screw operates along its respective longitudinal axis and can be set to a distinct axial position relative to the corresponding upper spring seat. As a result, one compression spring may be subjected to a higher initial preload than the other, which directly influences the force-displacement behavior during operation. In a practical implementation, this allows a clinician or user to compensate for muscular imbalance between the left and right sides of the cervical region. For example, if one side exhibits reduced strength, the preload adjustment screw on that side may be set to a lower initial compression, thereby reducing the resistance threshold and enabling targeted engagement without overloading the weaker muscle group, while the opposing side may be set at a higher preload to maintain adequate resistance.

During actuation, when the force transmission rod undergoes axial displacement, the bifurcated proximal engagement portion simultaneously contacts both upper spring seats; however, due to the differing initial preload conditions, the resulting compression response of each spring is not identical. The spring with the lower preload begins to compress earlier and may exhibit a greater displacement for the same applied force, whereas the spring with the higher preload requires a greater force threshold before significant compression occurs. This controlled asymmetry enables differential loading within a single motion cycle without altering the structural alignment or motion path of the apparatus. The ability to produce such differentiated responses while maintaining synchronized mechanical engagement enhances the adaptability of the device for varied therapeutic and training scenarios.

The orientation and fixation of the pivot pin play a critical role in maintaining consistent motion conversion within the system. The pivot pin is oriented perpendicular to the plane defined by the bifurcated proximal engagement portion, which corresponds to the plane in which the engagement arms interact with the upper spring seats. This perpendicular arrangement ensures that rotational motion of the mouthpiece arm assembly occurs about a stable and well-defined axis that does not interfere with the axial alignment of the force transmission rod. The pivot pin is rigidly fixed relative to the collar body frame, thereby establishing a non-translating rotational reference point. This fixed orientation ensures that all rotational motion is confined to the mouthpiece arm assembly and that no unintended displacement occurs at the pivot interface.

The pivot interface block is secured to the mouthpiece arm assembly such that it rotates as a single unit about the pivot pin. This configuration confines rotational movement exclusively to the mouthpiece arm assembly while the pivot pin remains stationary relative to the collar body frame. As a result, when a user applies force to the detachable mouthpiece interface, the induced rotation is consistently translated into linear displacement of the force transmission rod through the predetermined geometric offset between the pivot axis and the rod axis. The confinement of rotation to the mouthpiece arm assembly eliminates variability that could arise from multi-axis movement or shifting pivot points, thereby ensuring that the conversion of rotational input into axial displacement remains uniform across repeated cycles.

In a representative operational scenario, when a user performs repeated actuation cycles, the fixed pivot orientation and constrained rotational behavior ensure that each cycle produces identical displacement characteristics for a given applied force. Even when asymmetric preload conditions are established, the motion path of the force transmission rod remains linear and predictable, allowing the differential resistance to be applied without compromising alignment or introducing lateral forces. This results in a system where variability in resistance is achieved through controlled preload adjustment rather than through changes in motion geometry.

The combined effect of independently adjustable preload mechanisms and a fixed, well-defined pivot arrangement ensures that the apparatus can deliver both symmetric and asymmetric resistance profiles while maintaining a stable and repeatable mechanical operation. The ability to tailor resistance independently on each side without altering the structural alignment or motion path enables precise targeting of muscle groups, while the constrained pivot mechanism ensures consistent conversion of user-applied force into controlled axial displacement, thereby supporting reliable and repeatable performance across diverse usage conditions.

In an embodiment, the longitudinal axis of the force transmission rod is offset from the pivot pin by a fixed radial distance such that rotation of the mouthpiece arm assembly produces linear displacement of the force transmission rod through lever action about the pivot pin, and wherein the internal reinforcement rib includes a plurality of guiding surfaces positioned at spaced intervals along the force transmission rod, the guiding surfaces being aligned parallel to the longitudinal axis and maintaining sliding engagement with the force transmission rod to constrain lateral displacement and torsional rotation.

In this embodiment, the spatial relationship between the pivot pin and the force transmission rod is deliberately configured to create a controlled lever mechanism that converts rotational input into predictable linear displacement. The longitudinal axis of the force transmission rod is positioned at a fixed radial offset from the pivot pin, such that when the mouthpiece arm assembly rotates about the pivot pin, the arc-shaped motion at the pivot is translated into a straight-line displacement of the rod. The magnitude of this displacement is governed by the angular rotation of the mouthpiece arm assembly and the defined offset distance, thereby establishing a consistent mechanical relationship between applied oral force and resulting spring compression. In a practical implementation, selecting a specific offset distance allows tuning of the mechanical advantage, where a larger offset produces greater linear displacement for a given angular rotation, enabling the device to be calibrated for different resistance ranges or user strength levels.

The fixed nature of this radial offset ensures that the conversion of motion remains uniform across all cycles of operation. For example, when a user repeatedly applies force through the mouthpiece interface during a training session, each rotational movement about the pivot pin generates the same proportional axial displacement of the force transmission rod, provided the applied force remains consistent. This repeatability eliminates variability in stroke length and ensures that the compression of the springs follows a predictable displacement profile, which is essential for controlled muscle training and measurement of performance progression.

The internal reinforcement rib within the outer arm housing serves as a structural and functional guide system that maintains strict alignment of the force transmission rod during this motion conversion process. The reinforcement rib incorporates multiple guiding surfaces distributed along the length of the rod, with each guiding surface oriented parallel to the longitudinal axis. These guiding surfaces are positioned at spaced intervals to provide continuous support along the rod, thereby preventing bending, lateral deviation, or torsional movement. In a representative configuration, the guiding surfaces may be formed as channels or rails that partially enclose the rod, ensuring that the rod remains constrained within a defined linear path while still permitting smooth axial translation.

During operation, as the mouthpiece arm assembly rotates and induces axial movement of the force transmission rod, the guiding surfaces maintain sliding engagement with the rod, ensuring that the motion remains strictly linear despite the rotational origin of the input. This is particularly important because, without such guidance, the offset geometry could introduce side loads or rotational tendencies that would disrupt alignment with the resistance modules. The distributed arrangement of guiding surfaces ensures that any forces acting on the rod are evenly supported along its length, thereby reducing localized stress concentrations and minimizing wear.

For instance, during high-load actuation where significant force is applied, the presence of multiple guiding surfaces prevents the rod from deflecting or twisting under load. This ensures that the axial force transmitted to the bifurcated engagement portion remains aligned with the central guide rods of the resistance modules. As a result, the compression springs are engaged uniformly without angular deviation, preserving the efficiency of force transfer and preventing uneven loading conditions.

The sliding interaction between the guiding surfaces and the force transmission rod is configured to provide low-friction movement while maintaining positional stability. This may be achieved through material selection, such as pairing a low-friction polymer guide surface with a hardened metallic rod, or through surface treatments that reduce frictional resistance. The controlled sliding engagement ensures that the rod can move freely in response to applied force while remaining constrained within the intended motion path.

By combining the lever-based motion conversion enabled by the fixed radial offset with the alignment control provided by the internal reinforcement rib, this embodiment ensures that rotational input is translated into precise and repeatable linear displacement without introducing instability or misalignment. The resulting motion is smooth, predictable, and confined to a single axis, enabling efficient transmission of force to the resistance modules and maintaining consistent operational behavior across repeated cycles.

In an embodiment, the force transmission rod is aligned along a central longitudinal axis extending between the first resistance module assembly and the second resistance module assembly and intersecting a midpoint defined by the collar body frame such that axial displacement of the force transmission rod produces equal compression of both compression springs when the preload adjustment screws are set to identical initial compression states.

In this embodiment, the force transmission rod is positioned such that its longitudinal axis coincides with a central reference line extending between the first resistance module assembly and the second resistance module assembly, the reference line intersecting a geometric midpoint defined by the collar body frame. This central alignment is established during fabrication by fixing the mounting openings and the pivot assembly relative to the collar body frame with predetermined dimensional tolerances, thereby ensuring that the axis of the force transmission rod remains equidistant from both resistance modules. As a result, when the apparatus is worn, the rod occupies a balanced position relative to the user's cervical anatomy, and any axial movement of the rod is inherently directed symmetrically toward both resistance module assemblies.

When the preload adjustment screws of both resistance modules are set to identical initial compression states, the upper spring seats of both assemblies begin from equivalent axial positions relative to their respective central guide rods. Under these conditions, the bifurcated proximal engagement portion of the force transmission rod engages both upper spring seats simultaneously with equal initial contact pressure. Upon application of force at the mouthpiece interface, the resulting axial displacement of the force transmission rod is transmitted equally to both engagement arms, and because the rod is centered, the displacement vector applied to each spring seat is identical in magnitude and direction.

In a practical operational scenario, when the user performs an actuation cycle, the central alignment ensures that both compression springs begin to deform at the same instant and progress through compression at the same rate. For example, if the force transmission rod advances by a displacement of 5 mm along its axis, each upper spring seat correspondingly translates by 5 mm along its respective central guide rod, provided that the preload conditions and spring constants are equal. This results in synchronized compression of both springs, generating a balanced resistance profile that is uniformly distributed across both sides of the apparatus.

The central positioning of the force transmission rod also ensures that no moment imbalance is introduced during operation. Because the applied force is distributed symmetrically, there is no tendency for the rod to deviate laterally or for one resistance module to experience a greater load than the other. This is particularly significant in repeated training cycles, where even minor asymmetries in force distribution can accumulate over time and lead to uneven wear or inconsistent performance. The central axis alignment prevents such deviations by maintaining a uniform load path that is equally shared between both resistance modules.

Additionally, the intersection of the force transmission rod axis with the midpoint of the collar body frame ensures that the mechanical response of the system remains consistent regardless of user orientation or minor positional variations during use. The collar body frame acts as a stabilizing structure that preserves this midpoint alignment, thereby ensuring that the rod continues to operate along the intended axis even under dynamic conditions. For instance, during extended exercise sessions, slight movements of the user's head or neck do not significantly alter the alignment of the rod relative to the resistance modules, as the collar body frame maintains the fixed spatial relationship.

The equal compression achieved through this central alignment contributes to uniform deformation of both compression springs, which in turn results in consistent force feedback to the user. This uniformity allows the user to experience balanced resistance during each actuation cycle, facilitating coordinated activation of bilateral muscle groups. Over repeated use, this leads to consistent mechanical behavior, as both resistance modules undergo identical loading and unloading cycles, reducing differential wear and maintaining long-term reliability of the apparatus.

By ensuring that the force transmission rod is centrally aligned and equidistant from both resistance module assemblies, this embodiment enables simultaneous and equal engagement of both compression springs under identical preload conditions, thereby providing a stable and repeatable mechanical response that supports balanced and consistent operation.

In an embodiment, the internal alignment shoulder is positioned between the threaded interface and the spring chamber cavity and forms a mechanical stop that engages the retaining head of the central guide rod prior to full compression of the compression spring, and wherein the upper spring seat and the lower spring seat include planar spring-contact surfaces extending perpendicular to the central guide rod and maintaining continuous contact with end coils of the compression spring during compression and decompression; and wherein the force transmission rod is in direct abutment with the upper spring seats without intermediate linkage elements such that axial displacement of the force transmission rod produces immediate compression of the compression springs.

In this embodiment, the internal alignment shoulder is strategically formed within the outer housing at a location between the threaded interface and the spring chamber cavity so as to function as a definitive travel-limiting feature for the central guide rod. The retaining head provided on the central guide rod is dimensioned to engage this internal alignment shoulder when the guide rod reaches a predetermined axial displacement. This engagement is configured to occur before the compression spring reaches a condition where adjacent coils come into contact, thereby ensuring that the spring operates strictly within its elastic deformation range. In a representative configuration, if the compression spring is capable of a maximum safe compression of a defined length before coil interference occurs, the spacing between the retaining head and the internal alignment shoulder is selected to be slightly less than that maximum, thereby introducing a safety margin. During operation, when the user applies a high level of force through the mouthpiece interface, the resulting displacement of the force transmission rod is transmitted through the upper spring seat and into the spring. As the compression approaches the predefined limit, the retaining head contacts the internal alignment shoulder, thereby halting further axial movement of the guide rod and preventing over-compression of the spring. This ensures that the spring is protected from structural fatigue, permanent deformation, or failure due to excessive loading.

The configuration of the upper spring seat and the lower spring seat further contributes to maintaining uniform compression behavior. Each of these spring seats is formed with planar spring-contact surfaces that are oriented perpendicular to the longitudinal axis of the central guide rod. These planar surfaces are designed to engage the end coils of the compression spring across their full circumference, thereby distributing the compressive load evenly. During both compression and decompression phases, the planar contact ensures that the end coils remain in full-surface engagement with the seats, preventing localized stress points or uneven deformation. In practical operation, as the upper spring seat translates along the guide rod under applied force, the perpendicular orientation of the contact surfaces ensures that the spring is compressed along a straight axis without tilting or skewing. Similarly, during the return phase, as the spring expands, the lower and upper spring seats maintain consistent contact with the spring ends, ensuring smooth and controlled restoration to the initial position.

The absence of intermediate linkage elements between the force transmission rod and the upper spring seats establishes a direct mechanical interface that enhances responsiveness and reduces transmission losses. The force transmission rod is positioned such that its proximal engagement portion is in immediate abutment with the upper spring seats, allowing axial movement of the rod to be transferred directly into displacement of the spring seats without delay or compliance. In a practical scenario, when the user initiates a force input through the mouthpiece interface, the resulting motion is conveyed through the mouthpiece arm assembly and directly into the force transmission rod. Because the rod is in direct contact with the upper spring seats, the springs begin to compress instantaneously as the rod advances, without any intermediate slack, play, or deformation that could otherwise reduce efficiency.

This direct load path also ensures that the magnitude of displacement applied to the force transmission rod corresponds precisely to the displacement experienced by the upper spring seats. For example, if the rod advances by a specific linear distance, the upper spring seats translate by the same amount along the central guide rods, provided that the preload conditions are already engaged. This one-to-one correspondence between rod displacement and spring compression contributes to a predictable and repeatable force-displacement relationship, which is essential for controlled training applications.

Furthermore, the integration of the mechanical stop provided by the internal alignment shoulder with the direct force transmission interface ensures that the system remains stable even under conditions of high load. When the displacement limit is reached, the stop absorbs the excess force without transmitting it into the spring beyond its allowable range, while the direct contact between the rod and the spring seats ensures that no energy is dissipated through intermediate components. This combination of controlled travel limitation and immediate force transfer results in a system that operates with high mechanical efficiency, reduced component wear, and consistent performance over repeated cycles.

By coordinating the positional limit defined by the internal alignment shoulder, the uniform load distribution provided by the planar spring-contact surfaces, and the direct abutment between the force transmission rod and the upper spring seats, this embodiment ensures precise control over spring compression, prevents structural overload, and maintains a continuous and efficient transmission of force throughout the operation of the apparatus.

In an embodiment, the detachable mouthpiece interface (110) is rigidly fixed to the distal end of the mouthpiece arm assembly such that force applied within the oral cavity is transmitted along a continuous rigid path through the mouthpiece arm assembly into the force transmission rod, and wherein the mouthpiece arm assembly maintains a fixed angular relationship between the detachable mouthpiece interface and the force transmission rod during rotation about the pivot joint such that direction of applied force remains aligned with the longitudinal axis of the force transmission rod.

In this embodiment, the detachable mouthpiece interface is secured to the distal end of the mouthpiece arm assembly through a rigid fixation arrangement that prevents relative movement between the mouthpiece interface and the structural elements of the arm assembly. The fixation may be achieved through a mechanically interlocking joint, such as a keyed insertion, threaded engagement, or press-fit coupling reinforced by a locking feature, ensuring that the mouthpiece interface behaves as an integral extension of the mouthpiece arm assembly during operation. This rigid connection establishes a continuous structural pathway from the point of force application within the oral cavity to the force transmission rod, eliminating any compliant or flexible interfaces that could otherwise absorb or dissipate energy. In a practical scenario, when the user exerts force by pressing or biting against the mouthpiece interface, the applied force is conveyed directly into the arm assembly without deformation or delay, thereby preserving the magnitude and direction of the input force.

The mouthpiece arm assembly itself is constructed to maintain a fixed angular relationship between the detachable mouthpiece interface and the force transmission rod, such that both components remain in a constant geometric alignment throughout the entire range of motion. This fixed relationship is ensured by integrating the force transmission rod within the arm assembly in a manner that constrains it to move only along its longitudinal axis while remaining structurally aligned with the distal mouthpiece interface. As the mouthpiece arm assembly rotates about the pivot joint, the relative orientation between the mouthpiece interface and the force transmission rod does not change, thereby ensuring that the direction of the applied force remains consistently aligned with the axis of the force transmission rod.

During operation, when the user applies force within the oral cavity, the mouthpiece interface transmits this force into the arm assembly along a defined direction. Because of the fixed angular relationship, this direction is inherently aligned with the longitudinal axis of the force transmission rod. As the arm assembly rotates about the pivot pin, the lever action induced by the offset geometry converts the rotational motion into axial displacement of the force transmission rod, but without altering the alignment of the applied force vector. This ensures that the force entering the system is always directed along the intended axis of compression, thereby enabling efficient transfer of energy into the resistance modules.

For example, during repeated training cycles, even as the mouthpiece arm assembly undergoes angular displacement about the pivot joint, the user continues to apply force in a consistent manner relative to the mouthpiece interface. The rigid connection ensures that this force is not diverted or misaligned due to changes in orientation, and the maintained angular relationship ensures that the force transmission rod receives the input along its axis of motion. This results in a stable and predictable mechanical response, where the magnitude of spring compression corresponds directly to the magnitude of applied force.

The absence of angular variation between the mouthpiece interface and the force transmission rod also prevents the introduction of lateral or torsional components of force that could otherwise lead to uneven loading of the resistance modules. In conventional systems where flexible or pivoting connections exist between the input interface and the transmission mechanism, variations in force direction can result in inefficient energy transfer and increased wear. In contrast, the rigid and fixed alignment in this embodiment ensures that all applied force contributes directly to axial displacement, thereby improving efficiency and reducing mechanical losses.

Additionally, the rigid load path extending from the mouthpiece interface through the arm assembly and into the force transmission rod enhances responsiveness by eliminating delays associated with deformation or slack. When the user initiates force, the system responds immediately, with no intermediate compliance that could dampen or delay motion. This immediate response is particularly beneficial in applications requiring precise control over movement and resistance, as it allows the user to experience a direct correlation between applied effort and resulting mechanical action.

By ensuring a continuous rigid force path and maintaining a fixed angular relationship between the mouthpiece interface and the force transmission rod, this embodiment enables accurate alignment of applied force, efficient transmission of mechanical energy, and consistent operation across repeated cycles, thereby supporting reliable and controlled performance of the apparatus.

In an embodiment, the collar body frame (102) maintains fixed spatial positioning of the first resistance module assembly, the second resistance module assembly, and the pivot joint such that displacement of the force transmission rod follows a repeatable linear path aligned with the central guide rods, and wherein simultaneous compression of the compression springs of the first resistance module assembly and the second resistance module assembly occurs in response to a single continuous displacement of the force transmission rod through the bifurcated proximal engagement portion.

In this embodiment, the collar body frame functions as a rigid structural backbone that defines and preserves the geometric relationships among the first resistance module assembly, the second resistance module assembly, and the pivot joint throughout all stages of operation. The frame is configured with mounting features that are manufactured to fixed tolerances so that once the resistance modules and pivot joint are secured, their relative positions do not vary under load. This fixed spatial arrangement establishes a stable reference geometry in which the longitudinal axes of the central guide rods of both resistance modules remain parallel and symmetrically disposed about a central plane passing through the collar body frame. The pivot joint is similarly anchored at a predetermined location relative to this plane, ensuring that the origin of rotational motion is consistently aligned with the intended path of force transmission.

As a consequence of this fixed arrangement, the force transmission rod, which is guided within the mouthpiece arm assembly, is constrained to move along a repeatable linear path that is collinear with the axes of the central guide rods. During assembly, the alignment is achieved by positioning the guiding features of the arm housing and the bifurcated engagement portion such that the rod's longitudinal axis intersects the midpoint between the two resistance modules. This ensures that when the mouthpiece arm assembly is actuated, the conversion of rotational motion into axial displacement produces movement strictly along this predefined line. In practical use, even when the user performs multiple cycles of actuation with varying force levels, the path of displacement does not deviate, thereby maintaining consistent interaction between the force transmission rod and the resistance modules.

The bifurcated proximal engagement portion plays a critical role in distributing the axial displacement generated by the force transmission rod. Because the engagement arms are fixed relative to each other and aligned with the respective upper spring seats, any linear movement of the rod is transmitted simultaneously to both resistance modules. When the user applies force through the mouthpiece interface, the resulting rotation of the mouthpiece arm assembly causes the force transmission rod to advance along its axis. This advancement brings both engagement arms into uniform contact with the upper spring seats, initiating compression of both springs at the same instant. The continuous nature of this displacement ensures that the compression process progresses in parallel for both springs without interruption or phase difference.

For example, in a training cycle where the force transmission rod is displaced by a defined distance, such as a few millimeters, both upper spring seats translate by the same amount along their respective central guide rods, provided that preload conditions are equal. This synchronized movement results in identical deformation of both compression springs, generating a balanced resistance profile that is evenly distributed across both sides of the apparatus. The absence of intermediate linkages or independent actuation paths ensures that this simultaneous compression is achieved through a single continuous motion, rather than through separate or sequential inputs.

The maintenance of a repeatable linear path for the force transmission rod also ensures that the direction of applied force remains aligned with the intended axes of compression. This alignment prevents the introduction of lateral forces or moments that could otherwise disrupt the uniform operation of the resistance modules. Over repeated cycles, the consistent alignment minimizes wear on the guiding surfaces and maintains the integrity of the spring compression process, thereby supporting long-term reliability.

Furthermore, the fixed spatial positioning provided by the collar body frame ensures that external factors such as minor shifts in user posture do not significantly affect the internal alignment of the apparatus. The frame acts as a stabilizing structure that preserves the relative positions of all critical components, allowing the mechanical system to operate within its designed parameters regardless of slight variations in user movement. This contributes to consistent performance and predictable resistance characteristics across different usage conditions.

By maintaining fixed spatial relationships among the resistance modules and pivot joint, and by ensuring that the force transmission rod follows a strictly defined linear path, this embodiment enables synchronized and efficient compression of both springs through a single continuous displacement, thereby providing a stable and repeatable mechanical response suitable for controlled training applications.

In an embodiment, expansion of the compression springs produces return displacement of the force transmission rod along the longitudinal axis while maintaining engagement between the engagement arms and the upper spring seats, wherein the guiding surfaces of the internal reinforcement rib maintain coaxial alignment between the force transmission rod and the central guide rods during both compression and return motion, wherein the preload adjustment screws define respective initial positions of the upper spring seats such that the compression springs operate within predetermined displacement ranges during actuation; and wherein displacement of the detachable mouthpiece interface produces a continuous mechanical load transfer from the detachable mouthpiece interface through the mouthpiece arm assembly and the force transmission rod into the compression springs along the central guide rods without interruption in the load path.

In this embodiment, the return phase of operation is governed by the stored elastic energy within the compression springs, which acts to restore the system to its initial configuration following release of the applied force. When the user reduces or removes force from the detachable mouthpiece interface, the compression springs expand along their respective central guide rods, generating a restoring force that acts on the upper spring seats. This restoring force is transmitted directly to the engagement arms of the bifurcated proximal engagement portion, thereby driving the force transmission rod in the reverse direction along its longitudinal axis. Because the engagement arms remain in continuous contact with the upper spring seats throughout the entire cycle, there is no disengagement or loss of contact during the transition from compression to expansion. This uninterrupted engagement ensures that the return motion is smooth and directly coupled, avoiding any sudden release, impact, or discontinuity that could otherwise arise in systems with intermittent contact.

The guiding surfaces formed by the internal reinforcement rib play a critical role in maintaining coaxial alignment between the force transmission rod and the central guide rods during both forward and return motion. These guiding surfaces are distributed along the length of the force transmission rod and are oriented parallel to its longitudinal axis, thereby constraining the rod to move strictly along a linear path. During the expansion phase, as the springs push the upper spring seats outward, the resulting reverse displacement of the force transmission rod is guided along the same axis established during compression. This ensures that the rod does not deviate laterally or undergo torsional movement, even under varying load conditions. In a practical example, during repeated cycles of actuation and release, the guiding surfaces maintain consistent alignment, thereby preventing cumulative misalignment that could otherwise affect performance or cause uneven wear.

The preload adjustment screws define the initial positions of the upper spring seats by establishing a predetermined compression state prior to actuation. These initial positions effectively set the operational range within which the compression springs function. During use, the displacement of the upper spring seats caused by the force transmission rod occurs relative to these predefined positions, ensuring that the springs operate within a controlled and predictable displacement range. For instance, if the preload adjustment screws are set to impose an initial compression of a certain magnitude, the subsequent compression during actuation occurs within a bounded range that avoids both underutilization and over-compression of the springs. This controlled range contributes to consistent resistance characteristics and ensures that the restoring force generated during expansion remains within expected limits.

The continuous mechanical load transfer established in this embodiment ensures that force applied at the detachable mouthpiece interface is transmitted without interruption through the entire system. The load path extends from the mouthpiece interface, through the rigid structure of the mouthpiece arm assembly, into the force transmission rod, and finally into the compression springs via the upper spring seats and central guide rods. At no point along this path is there a flexible or decoupled interface that could introduce delay, energy loss, or misalignment. During both compression and return phases, this continuous load path ensures that the relationship between applied force and resulting displacement remains consistent and predictable.

In a representative usage scenario, when a user performs a sequence of actuation cycles, each cycle begins with the application of force that produces axial displacement of the force transmission rod and compression of the springs. Upon release, the springs expand and drive the rod back along the same path, restoring the system to its initial position defined by the preload adjustment screws. The maintained engagement between the engagement arms and the upper spring seats ensures that this cycle is executed without interruption, while the guiding surfaces preserve alignment throughout. This coordinated interaction results in a system that exhibits smooth cyclic behavior, stable force response, and consistent displacement characteristics across repeated operations.

By integrating controlled spring expansion, continuous engagement, guided alignment, and a predefined operational range established by preload adjustment, this embodiment ensures that both the forward and return phases of motion are executed in a stable, repeatable, and mechanically efficient manner, thereby supporting reliable and consistent performance of the apparatus.

In an embodiment, the bifurcated proximal engagement portion of the force transmission rod is positioned such that each engagement arm is aligned along a respective longitudinal axis of the central guide rod of the first resistance module assembly and the second resistance module assembly, and wherein the planar contact interface of each engagement arm engages a central region of the corresponding upper spring seat intersecting the central bore, the alignment maintaining collinear force transfer from the force transmission rod into the compression springs during both compression and return motion; and wherein the central guide rod, the preload adjustment screw, and the force transmission rod are arranged along substantially parallel axes, and wherein axial displacement of the force transmission rod is transmitted into the compression spring through the upper spring seat without angular deviation, the arrangement maintaining linear compression of the compression spring within the spring chamber cavity.

In this embodiment, the bifurcated proximal engagement portion is dimensioned and positioned such that each engagement arm is precisely aligned with the longitudinal axis of a corresponding central guide rod of the respective resistance module assemblies. This alignment is established during assembly by fixing the spatial relationship between the collar body frame, the resistance modules, and the force transmission rod so that each engagement arm lies directly along the extension of the guide rod axis. As a result, when the force transmission rod undergoes axial displacement, the line of action of the applied force coincides with the axis along which each compression spring is designed to deform. This eliminates any offset loading condition that could otherwise introduce bending or shear components into the system.

The planar contact interface of each engagement arm is configured to engage a central region of the upper spring seat, specifically at a location intersecting the central bore through which the guide rod passes. By concentrating the point of engagement at this central region, the applied force is directed through the geometric center of the spring seat, ensuring that the load is transmitted uniformly into the compression spring. In practical operation, when the force transmission rod advances, the engagement arms contact the upper spring seats at these central locations, causing the seats to translate along the guide rods without tilting. For example, during repeated compression cycles, this central engagement prevents eccentric loading that might otherwise cause uneven deformation of the spring coils or increased friction between the spring and the chamber walls.

The arrangement of the central guide rod, the preload adjustment screw, and the force transmission rod along substantially parallel axes further reinforces the linearity of the force transmission pathway. Each of these components is oriented such that their longitudinal axes do not intersect or diverge but remain parallel within the structural confines of the apparatus. This parallel configuration ensures that forces introduced at the mouthpiece interface are propagated through the system without angular deviation. The preload adjustment screw applies its compressive influence along the same directional axis as the force transmission rod, and both act in alignment with the central guide rod that governs spring compression. This geometric consistency prevents the introduction of secondary force components that could destabilize the motion of the spring seats.

During actuation, when the user applies force and the mouthpiece arm assembly induces axial displacement of the force transmission rod, the engagement arms transmit this displacement directly into the upper spring seats along the aligned axes. Because the contact occurs centrally and the axes are parallel, the upper spring seats move strictly along the guide rods, compressing the springs in a uniform and concentric manner. The absence of angular deviation ensures that each coil of the compression spring is subjected to an equal portion of the applied load, thereby maintaining structural stability and consistent resistance characteristics.

In the return phase, as the compression springs expand, the same alignment conditions ensure that the restoring force is transmitted back through the upper spring seats and into the force transmission rod without deviation. The engagement arms remain aligned with the guide rods, and the planar contact interfaces maintain central engagement, allowing the force transmission rod to retract along the same linear path established during compression. This bidirectional alignment ensures that both compression and decompression cycles occur along identical paths, contributing to repeatable system behavior.

In a practical usage scenario, such as continuous therapeutic exercise involving multiple repetitions, the described alignment prevents cumulative misalignment and reduces wear on the interacting components. The springs maintain their concentric configuration within the spring chamber cavities, the guide rods remain free of lateral stress, and the engagement interfaces experience uniform contact pressure. This results in smooth operation, consistent resistance output, and extended durability of the apparatus.

By ensuring that each engagement arm is collinearly aligned with its corresponding guide rod, that contact occurs at the central region of the upper spring seats, and that all principal components are arranged along parallel axes, this embodiment establishes a force transmission pathway that is strictly linear and free from angular deviation, thereby enabling precise and stable compression of the springs within the system.

In an embodiment, the internal alignment shoulder and the retaining head of the central guide rod define a bounded axial travel range of the central guide rod, the bounded axial travel range being less than a maximum compression length of the compression spring defined by adjacent coil contact, such that engagement between the retaining head and the internal alignment shoulder occurs prior to coil stacking of the compression spring.

In this embodiment, the internal alignment shoulder and the retaining head of the central guide rod cooperate to define a precisely controlled axial travel envelope that governs the permissible displacement of the spring-guiding assembly during operation. The internal alignment shoulder is formed as an inwardly projecting annular feature within the outer housing at a predetermined axial position relative to the spring chamber cavity, while the retaining head is formed at an end of the central guide rod with a diameter greater than that of the rod shaft. The axial spacing between these two features is selected during design to correspond to a displacement limit that is intentionally shorter than the theoretical maximum compression length of the compression spring, which would otherwise be reached when adjacent coils come into direct contact.

In practical implementation, the maximum allowable compression of the spring is first characterized based on its material properties, wire diameter, coil geometry, and number of active turns. A safe operating compression length is then derived by introducing a margin below the coil-to-coil contact condition. The distance between the retaining head and the internal alignment shoulder is set to match this safe operating length, thereby ensuring that the central guide rod cannot travel beyond a predefined limit. For example, if a given spring exhibits coil contact at a compression of 10 mm, the spacing between the retaining head and the internal alignment shoulder may be established at approximately 8 mm, thereby restricting the travel of the guide rod to a value that maintains the spring within its elastic range.

During operation, when the force transmission rod advances and applies compressive force through the upper spring seat, the spring begins to compress along the central guide rod. As the upper and lower spring seats translate, the guide rod itself moves within the outer housing until the retaining head approaches the internal alignment shoulder. Upon reaching the predetermined displacement limit, the retaining head engages the internal alignment shoulder, forming a mechanical stop that prevents further axial movement. This engagement occurs before the spring coils are forced into contact with one another, thereby avoiding the onset of coil stacking, which is typically associated with a sharp increase in stiffness and potential material overstress.

The engagement between the retaining head and the internal alignment shoulder provides a controlled termination of motion that absorbs additional applied force without transmitting it into further compression of the spring. In a scenario where a user applies excessive force, the stop mechanism ensures that the additional load is redirected into the structural interface between the retaining head and the housing, rather than being imposed on the spring. This prevents plastic deformation of the spring material, reduces the likelihood of fatigue-induced failure, and preserves the repeatable force-displacement characteristics of the spring over extended usage.

Furthermore, the bounded axial travel ensures that each actuation cycle occurs within a consistent displacement range, which contributes to predictable system behavior. Because the maximum travel is fixed by the mechanical stop, the relationship between applied force and resulting displacement remains stable across repeated cycles. This is particularly important in applications requiring controlled and repeatable resistance, as it ensures that the user experiences the same mechanical response under similar operating conditions.

The presence of the defined travel limit also contributes to maintaining alignment within the spring chamber cavity. By preventing excessive displacement, the system avoids conditions in which the spring could become unstable or experience lateral deformation. The central guide rod continues to maintain concentric alignment of the spring throughout the allowable travel range, and the engagement of the retaining head with the internal alignment shoulder occurs without introducing misalignment or shock loading, due to the controlled nature of the displacement limit.

Over prolonged usage, such as repeated daily operation, the bounded travel range minimizes wear on the spring and associated components by preventing operation in regions of high stress or mechanical instability. The consistent limitation of motion ensures that the spring operates within a regime where its material properties remain stable, thereby supporting long-term durability and consistent performance.

By defining a travel range that is deliberately less than the maximum compression length of the spring and by ensuring that the stop engagement occurs prior to coil stacking, this embodiment provides a controlled and protective mechanism that governs spring operation, maintains structural integrity, and ensures consistent mechanical behavior throughout the lifespan of the apparatus.

In an embodiment, the preload adjustment screw (106) is positioned such that the distal contact surface applies compressive preload directly to the upper spring seat along the longitudinal axis of the central guide rod, and wherein rotation of the preload adjustment screw produces incremental linear displacement of the distal contact surface within the spring chamber cavity corresponding to thread advancement within the threaded interface.

In this embodiment, the preload adjustment screw is arranged so that its distal contact surface is coaxially aligned with the longitudinal axis of the central guide rod, thereby enabling direct transmission of compressive force into the upper spring seat without introducing any lateral or angular components. The threaded interface formed within the outer housing is machined such that the axis of the screw coincides with the axis of the spring chamber cavity, ensuring that the distal contact surface advances and retracts strictly along the same line as the central guide rod. This configuration allows the preload force to be applied centrally to the upper spring seat, which in turn transfers the load uniformly into the compression spring along its axis of deformation.

During adjustment, rotation of the preload adjustment screw produces linear displacement of the distal contact surface as a function of the thread pitch. The relationship between rotational input and axial movement is governed by the geometry of the threaded engagement, such that each incremental rotation results in a corresponding and predictable translation of the distal contact surface within the spring chamber cavity. For example, if the screw is designed with a fine pitch, a small angular rotation-such as a quarter turn-produces a small and controlled axial displacement, enabling precise calibration of the preload condition. This incremental adjustment allows the user or clinician to set the initial compression of the spring with a high degree of accuracy, ensuring that the resistance profile of the apparatus can be tailored to specific requirements.

As the distal contact surface advances toward the upper spring seat, it first eliminates any initial gap and then begins to exert compressive force, causing the upper spring seat to translate along the central guide rod and compress the spring. Because the contact occurs along the central axis, the applied preload is distributed evenly across the spring, maintaining concentric deformation and preventing skewing or uneven stress distribution. This central loading condition is maintained throughout the adjustment process, ensuring that the spring remains properly aligned within the spring chamber cavity.

In practical use, this arrangement enables the establishment of a defined baseline resistance prior to actuation. For instance, in a therapeutic setting, the preload may be set to a lower value for initial sessions, allowing the user to perform movements with reduced resistance. As strength improves, the preload adjustment screw can be rotated further to increase the initial compression of the spring, thereby raising the resistance encountered during operation. The incremental nature of the adjustment ensures that these changes can be made gradually and reproducibly, facilitating controlled progression in training intensity.

The direct application of preload through the distal contact surface also eliminates the need for intermediary components, thereby reducing mechanical complexity and potential sources of misalignment. The absence of additional linkages ensures that the displacement introduced by the screw is transmitted immediately and fully to the upper spring seat, resulting in a one-to-one correspondence between screw advancement and spring compression. This direct relationship enhances the predictability of the system and simplifies calibration.

Furthermore, the threaded engagement inherently provides positional stability due to friction between the mating threads, which resists unintended rotation during operation. This ensures that once a preload setting is established, it remains consistent across multiple actuation cycles without the need for additional locking mechanisms. The maintained preload condition contributes to a stable and repeatable force-displacement response, as the initial position of the upper spring seat does not vary during use.

By positioning the preload adjustment screw to act directly along the central guide rod axis and by utilizing the controlled linear translation generated through threaded advancement, this embodiment enables precise, stable, and repeatable establishment of preload conditions, thereby supporting consistent and adaptable operation of the resistance mechanism.

In an embodiment, the pivot joint is configured such that the pivot pin defines a fixed axis relative to the collar body frame and the pivot interface block rotates about the pivot pin, and wherein the mouthpiece arm assembly translates rotational displacement into linear displacement of the force transmission rod through an offset between the pivot pin and the longitudinal axis of the force transmission rod; and wherein the internal reinforcement rib includes a plurality of longitudinally extending guide channels formed within the outer arm housing, the guide channels receiving the force transmission rod in sliding engagement such that axial movement of the force transmission rod is permitted while lateral displacement and rotational movement of the force transmission rod relative to the outer arm housing are restricted.

In this embodiment, the pivot joint is constructed so that the pivot pin is rigidly anchored within the collar body frame, thereby establishing a fixed and immovable rotational axis that serves as the reference for all motion of the mouthpiece arm assembly. The pivot interface block is mounted around the pivot pin with a controlled clearance fit that permits smooth rotation while preventing axial or lateral displacement relative to the pin. This configuration ensures that when the user applies force at the mouthpiece interface, the resulting motion is constrained to pure rotation about a single, well-defined axis, eliminating any ambiguity in the direction or nature of the movement. In a practical implementation, the pivot pin may be secured through interference fitting or mechanical fastening within the collar body frame, while the pivot interface block may include a bearing surface or low-friction lining to facilitate repeated rotational cycles without degradation.

The conversion of this rotational movement into linear displacement is achieved through the deliberate offset between the pivot pin and the longitudinal axis of the force transmission rod. Because the force transmission rod is positioned at a fixed radial distance from the pivot axis, any angular rotation of the mouthpiece arm assembly produces a corresponding linear translation of the rod. This lever-based conversion is governed by the geometry of the offset, such that the magnitude of linear displacement is directly related to the angular displacement about the pivot pin. For example, when the mouthpiece arm assembly rotates through a small angle under user-applied force, the distal portion of the assembly follows an arc, while the constrained force transmission rod is compelled to move along its longitudinal axis, thereby producing a predictable and repeatable displacement. This arrangement ensures that the input force applied within the oral cavity is effectively transformed into a controlled axial motion that can be transmitted to the resistance modules.

The internal reinforcement rib, formed within the outer arm housing, provides a structural framework that maintains the alignment and stability of the force transmission rod during this motion conversion process. The rib incorporates a series of longitudinally extending guide channels that are precisely dimensioned to receive the force transmission rod in sliding engagement. These guide channels are oriented parallel to the longitudinal axis of the rod and are distributed along its length to provide continuous support. The sliding engagement between the rod and the guide channels allows the rod to move freely in the axial direction while preventing any lateral displacement or rotational movement relative to the outer arm housing.

During operation, as the mouthpiece arm assembly rotates about the pivot pin, the force transmission rod is driven along its axis within the guide channels. The channels constrain the rod such that it cannot deviate from its intended path, even under varying load conditions. For instance, when a user applies a relatively high force, the resulting load transmitted through the rod could introduce tendencies for bending or twisting; however, the distributed guide channels counteract these tendencies by providing multiple points of support along the rod's length. This ensures that the rod remains aligned with the central axes of the resistance modules, thereby preserving the efficiency of force transfer.

The restriction of lateral and rotational movement is particularly important in maintaining consistent engagement between the bifurcated proximal engagement portion and the upper spring seats. Because the rod is prevented from rotating about its own axis or shifting sideways, the engagement arms remain properly oriented relative to the spring seats throughout the entire actuation cycle. This contributes to uniform compression of the springs and prevents uneven wear or misalignment of the contact surfaces.

In repeated use, such as continuous exercise sessions, the combination of a fixed pivot axis and guided linear motion ensures that each cycle of operation follows the same mechanical pathway. The pivot joint provides a stable origin for rotational input, the offset geometry ensures consistent conversion to linear displacement, and the guide channels maintain alignment of the force transmission rod. This integrated arrangement results in smooth, predictable motion with minimal mechanical loss, enabling reliable and repeatable performance over extended periods.

By defining a fixed rotational axis, employing an offset-based motion conversion, and constraining the force transmission rod within longitudinal guide channels, this embodiment ensures precise transformation of user-applied force into controlled linear displacement while maintaining alignment, stability, and consistent interaction with the resistance modules.

In an embodiment, the force transmission rod maintains continuous mechanical engagement with the upper spring seats during both compression and decompression of the compression springs, the engagement preventing disengagement of the bifurcated proximal engagement portion from the upper spring seats throughout a full actuation cycle; and wherein the mouthpiece arm assembly maintains a fixed angular relationship between the detachable mouthpiece interface and the force transmission rod such that a direction of applied force at the detachable mouthpiece interface remains aligned with the longitudinal axis of the force transmission rod during rotation about the pivot joint.

In this embodiment, the force transmission rod is dimensioned and positioned such that its bifurcated proximal engagement portion remains in uninterrupted contact with the upper spring seats throughout the entire range of motion, including both the compression phase and the decompression phase of the compression springs. The engagement arms are configured with a length and positional offset that ensure that even at the extreme limits of axial displacement, contact with the upper spring seats is not lost. This continuous engagement is achieved by maintaining a controlled clearance between the engagement arms and the surrounding structural elements, such that the arms are free to translate axially while remaining in constant abutment with the spring seats. In a practical configuration, the stroke length of the force transmission rod is selected to be fully contained within the engagement range defined by the geometry of the engagement arms and the initial positions of the spring seats established by the preload adjustment screws.

During operation, when the user applies force at the mouthpiece interface, the force transmission rod advances axially, and the engagement arms push against the upper spring seats to compress the springs. Because the engagement is continuous, there is no intermediate phase in which the arms separate from the spring seats, thereby eliminating any delay or slack in the transmission of force. As the applied force is reduced and the compression springs expand, the upper spring seats move in the opposite direction and remain in contact with the engagement arms, thereby pulling or guiding the force transmission rod back along its axis. This bidirectional engagement ensures that both forward and return motions are governed by direct mechanical interaction, resulting in a smooth and controlled cyclic operation.

The prevention of disengagement throughout the actuation cycle also eliminates impact loading or sudden re-engagement that could occur if the components were to separate and then come back into contact. In conventional systems where intermittent contact is present, such re-engagement can lead to noise, wear, and unpredictable force transmission. In contrast, the maintained contact in this embodiment ensures that the transition between compression and decompression occurs seamlessly, preserving the integrity of the load path and reducing mechanical stress on the interacting components.

Simultaneously, the mouthpiece arm assembly is constructed to maintain a fixed angular relationship between the detachable mouthpiece interface and the force transmission rod. This fixed relationship is achieved by integrating the rod within the structural framework of the arm assembly such that its orientation relative to the mouthpiece interface does not vary during rotation about the pivot joint. As a result, when the user applies force within the oral cavity, the direction of that force remains aligned with the longitudinal axis of the force transmission rod regardless of the angular position of the arm assembly.

During rotation about the pivot pin, the mouthpiece arm assembly undergoes angular displacement, but the internal alignment between the mouthpiece interface and the force transmission rod ensures that the applied force vector is consistently directed along the axis of the rod. This alignment is critical in ensuring that the force is converted efficiently into axial displacement without introducing lateral or torsional components. For example, as the user performs repeated actuation cycles, the consistent alignment of the applied force ensures that each cycle produces a uniform displacement of the force transmission rod and, consequently, uniform compression of the springs.

The combined effect of continuous engagement and maintained angular alignment results in a system where the force applied by the user is transmitted in a stable and uninterrupted manner throughout the entire motion cycle. The absence of disengagement ensures that the mechanical response is immediate and continuous, while the fixed angular relationship ensures that the direction of force application remains optimal for axial transmission. This coordinated interaction contributes to consistent performance, reduced mechanical losses, and enhanced durability of the apparatus under repeated use conditions.

In an embodiment, the collar body frame (102) maintains fixed spatial relationships between the first resistance module assembly, the second resistance module assembly, and the pivot joint such that displacement of the force transmission rod occurs along a repeatable linear path aligned with the central guide rods, the repeatable linear path maintaining symmetrical compression of the compression springs when preload conditions are identical; and wherein expansion of the compression springs following release of force applied at the detachable mouthpiece interface produces return displacement of the force transmission rod toward the initial position defined by the preload adjustment screws while maintaining sliding engagement between the force transmission rod and the guiding surfaces of the internal reinforcement rib.

In this embodiment, the collar body frame serves as a rigid structural datum that preserves the positional relationships among the first resistance module assembly, the second resistance module assembly, and the pivot joint with high dimensional stability during both static and dynamic conditions of use. The mounting interfaces for the resistance modules and the pivot joint are formed in the collar body frame with predetermined tolerances such that, once assembled, the axes of the central guide rods and the pivot axis remain fixed relative to one another. This fixed geometry establishes a deterministic motion pathway for the force transmission rod, ensuring that its longitudinal axis remains collinear with the axes of the central guide rods throughout the full range of operation. In practice, even under repeated loading cycles or minor variations in user posture, the collar body frame resists deformation and prevents relative shifting of the components, thereby maintaining the intended alignment.

When the preload adjustment screws of both resistance modules are set to identical initial compression states, the upper spring seats occupy equivalent starting positions along their respective central guide rods. Under these conditions, the bifurcated proximal engagement portion of the force transmission rod engages both upper spring seats symmetrically. As the user applies force at the detachable mouthpiece interface, the resulting rotation of the mouthpiece arm assembly is converted into axial displacement of the force transmission rod along the established linear path. Because this path is aligned with the central guide rods and centrally located between the resistance modules, the displacement is imparted equally to both upper spring seats. For example, if the force transmission rod advances by a defined linear distance, both spring seats translate by the same amount, resulting in equal compression of the corresponding compression springs. This symmetry ensures that the mechanical response on both sides remains balanced, promoting uniform loading conditions and consistent behavior across repeated actuation cycles.

The repeatability of the linear path is further reinforced by the guiding interaction between the force transmission rod and the internal reinforcement rib within the mouthpiece arm assembly. The guiding surfaces formed by the rib maintain the rod in sliding engagement, constraining it to axial movement while preventing lateral deviation or rotational misalignment. During forward motion, this guidance ensures that the rod advances along the same axis in every cycle, preserving alignment with the central guide rods and maintaining consistent engagement with the upper spring seats. This controlled motion path prevents the accumulation of positional errors that could otherwise arise from repeated use.

Upon release of the applied force at the detachable mouthpiece interface, the compression springs expand along their respective central guide rods, generating a restoring force that acts on the upper spring seats. This restoring force is transmitted through the engagement arms of the force transmission rod, causing the rod to retract along the same linear path toward its initial position. The return displacement is governed by the preload adjustment screws, which define the initial positions of the upper spring seats and thus establish the endpoint of the return motion. As the springs expand, the engagement between the force transmission rod and the upper spring seats is maintained, ensuring that the retraction occurs in a controlled and continuous manner.

During this return phase, the sliding engagement between the force transmission rod and the guiding surfaces of the internal reinforcement rib remains active, ensuring that the rod retracts without deviation from its defined axis. The guiding surfaces support the rod along its length, preventing any lateral movement or twisting that could disrupt alignment with the resistance modules. This ensures that the return motion mirrors the forward motion in both direction and magnitude, resulting in a consistent cyclic operation.

In a practical usage scenario involving repeated actuation cycles, such as therapeutic training sessions, the described configuration ensures that each cycle follows the same mechanical pathway, with identical displacement characteristics and balanced spring compression when preload conditions are equal. The collar body frame maintains the structural integrity of the system, the guiding surfaces preserve alignment during motion, and the preload adjustment screws define consistent boundary conditions for both compression and return. This coordinated interaction results in stable and predictable performance, reduced mechanical wear, and sustained reliability of the apparatus over extended periods of use.

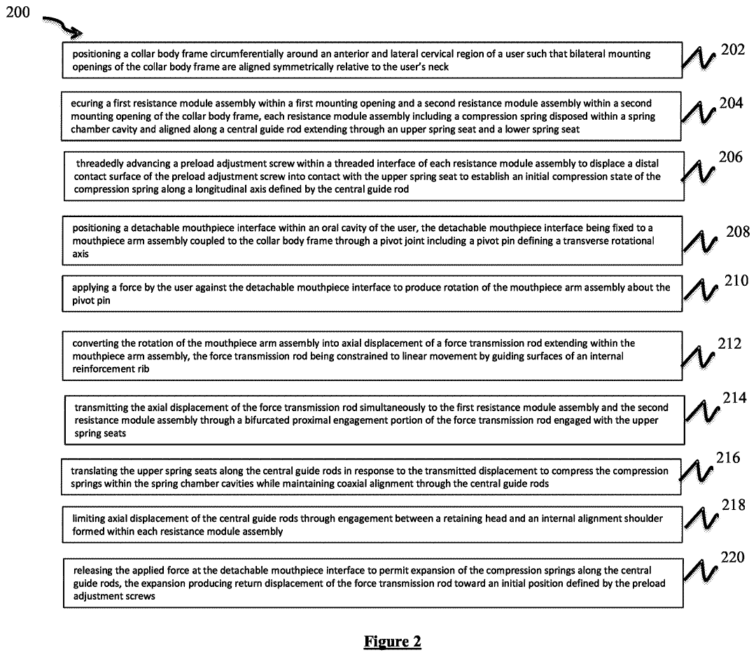

Referring to FIG. 2, a flow chart of a method of operating a wearable throat muscle training apparatus, the method comprising is illustrated. The method 200 comprising:
At step 202, the method 200 includes positioning a collar body frame circumferentially around an anterior and lateral cervical region of a user such that bilateral mounting openings of the collar body frame are aligned symmetrically relative to the user's neck;
At step 204, the method 200 includes securing a first resistance module assembly within a first mounting opening and a second resistance module assembly within a second mounting opening of the collar body frame, each resistance module assembly including a compression spring disposed within a spring chamber cavity and aligned along a central guide rod extending through an upper spring seat and a lower spring seat;
At step 206, the method 200 includes threadedly advancing a preload adjustment screw within a threaded interface of each resistance module assembly to displace a distal contact surface of the preload adjustment screw into contact with the upper spring seat to establish an initial compression state of the compression spring along a longitudinal axis defined by the central guide rod;
At step 208, the method 200 includes positioning a detachable mouthpiece interface within an oral cavity of the user, the detachable mouthpiece interface being fixed to a mouthpiece arm assembly coupled to the collar body frame through a pivot joint including a pivot pin defining a transverse rotational axis;
At step 210, the method 200 includes applying a force by the user against the detachable mouthpiece interface to produce rotation of the mouthpiece arm assembly about the pivot pin;
At step 212, the method 200 includes converting the rotation of the mouthpiece arm assembly into axial displacement of a force transmission rod extending within the mouthpiece arm assembly, the force transmission rod being constrained to linear movement by guiding surfaces of an internal reinforcement rib;
At step 214, the method 200 includes transmitting the axial displacement of the force transmission rod simultaneously to the first resistance module assembly and the second resistance module assembly through a bifurcated proximal engagement portion of the force transmission rod engaged with the upper spring seats;
At step 216, the method 200 includes translating the upper spring seats along the central guide rods in response to the transmitted displacement to compress the compression springs within the spring chamber cavities while maintaining coaxial alignment through the central guide rods;
At step 218, the method 200 includes limiting axial displacement of the central guide rods through engagement between a retaining head and an internal alignment shoulder formed within each resistance module assembly; and
At step 220, the method 200 includes releasing the applied force at the detachable mouthpiece interface to permit expansion of the compression springs along the central guide rods, the expansion producing return displacement of the force transmission rod toward an initial position defined by the preload adjustment screws.

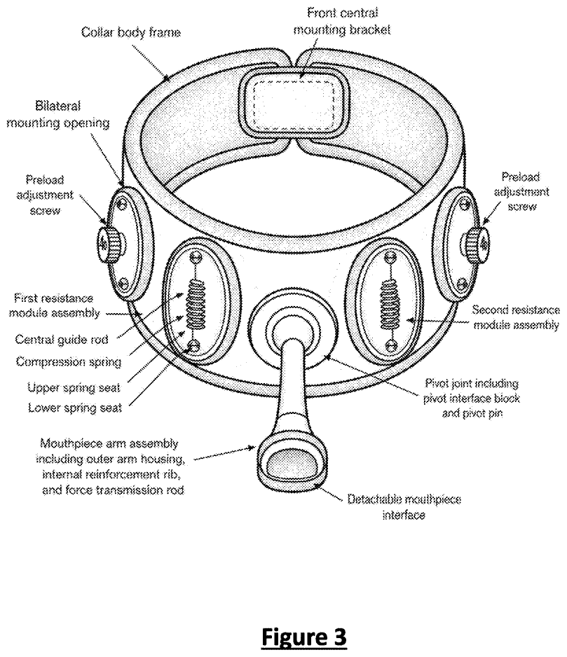

FIG. 3 illustrates a complete assembled configuration of the wearable throat muscle training apparatus, depicting the spatial arrangement, structural integration, and functional interconnection of the collar body frame, resistance module assemblies, pivot mechanism, and force transmission system in accordance with an embodiment of the invention. The collar body frame is shown as a continuous annular structure configured to circumferentially engage the anterior and lateral cervical region of a user, wherein the frame provides a rigid and stable support platform that maintains fixed spatial positioning of all operative components. The inner contour of the collar body frame is shaped to conform to the neck profile, while the outer surface incorporates multiple mounting interfaces that are precisely positioned to ensure symmetrical distribution of mechanical elements about a vertical midline.

On opposite lateral sides of the collar body frame, bilateral mounting openings are formed, each receiving a respective resistance module assembly. These mounting openings are structurally integrated into the frame such that the resistance modules are fixed in position and aligned along parallel longitudinal axes. Each resistance module assembly is enclosed within an outer housing and includes a spring chamber cavity within which a compression spring is disposed. The compression spring is shown concentrically arranged around a central guide rod that extends axially through the spring and through aligned bores of an upper spring seat and a lower spring seat. The central guide rod ensures that both spring seats translate along a strictly linear path while maintaining concentric alignment of the compression spring during operation. The upper and lower spring seats are positioned at opposite ends of the compression spring and are configured with planar contact surfaces that maintain full-surface engagement with the end coils of the spring throughout compression and decompression cycles.

Each resistance module further includes a preload adjustment screw positioned on the outer side of the housing, accessible for manual adjustment. The preload adjustment screw is aligned coaxially with the central guide rod and is threaded into the housing such that rotation of the screw produces linear displacement of its distal contact surface. This distal contact surface engages the upper spring seat to impose an initial compression state on the spring, thereby establishing a predefined resistance level. The figure shows the preload adjustment screws on both sides, indicating that each resistance module can be independently adjusted to achieve either symmetrical or asymmetrical resistance profiles.

At the front central region of the collar body frame, a front central mounting bracket is provided, which supports a pivot joint assembly. The pivot joint includes a pivot interface block and a pivot pin that defines a fixed transverse rotational axis relative to the collar body frame. The pivot interface block is attached to the mouthpiece arm assembly, allowing the arm assembly to rotate about the pivot pin while the pivot pin itself remains stationary with respect to the collar body frame. This configuration ensures that rotational motion is confined to the mouthpiece arm assembly and is consistently referenced to the fixed geometry of the collar body frame.

Extending forward from the pivot joint is the mouthpiece arm assembly, which comprises an outer arm housing enclosing an internal reinforcement rib and a force transmission rod. The internal reinforcement rib is formed within the arm housing and includes guiding surfaces that constrain the force transmission rod to axial movement along its longitudinal axis. The force transmission rod extends through the arm assembly and is aligned centrally between the two resistance module assemblies. At its proximal end, the force transmission rod includes a bifurcated engagement portion (not explicitly visible in full detail but implied by the structure) that interfaces with the upper spring seats of both resistance modules, thereby enabling simultaneous transmission of force to both springs.

At the distal end of the mouthpiece arm assembly, a detachable mouthpiece interface is provided, which is configured for placement within the oral cavity of the user. The mouthpiece interface is rigidly fixed to the arm assembly, forming a continuous mechanical path for force transmission. When a user applies force through the mouthpiece interface, the mouthpiece arm assembly rotates about the pivot pin. Due to the offset between the pivot axis and the longitudinal axis of the force transmission rod, this rotational motion is converted into linear displacement of the force transmission rod. This displacement is transmitted through the bifurcated engagement portion to the upper spring seats, causing both compression springs to compress along their respective central guide rods.

The figure further illustrates that all components are arranged in a manner that ensures alignment of the force transmission rod with the central guide rods of the resistance modules. This alignment enables collinear force transfer and prevents angular deviation during operation. The structural integration of the collar body frame, resistance modules, pivot joint, and mouthpiece arm assembly ensures that the applied force follows a continuous and uninterrupted load path from the mouthpiece interface to the compression springs. FIG. 3 demonstrates how the apparatus achieves synchronized bilateral resistance through a single actuation input, while maintaining precise alignment, controlled displacement, and repeatable mechanical behavior. The illustrated configuration highlights the interaction of the preload adjustment mechanism, guided spring compression system, and pivot-driven force transmission assembly, thereby providing a comprehensive representation of the device structure and its operational principles in accordance with an embodiment of the invention.

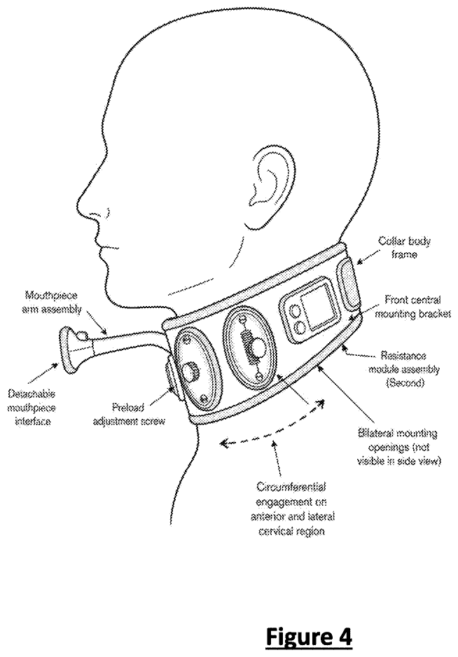

FIG. 4 illustrates a side-view representation of the wearable throat muscle training apparatus in an operational position on a user, highlighting the anatomical alignment of the device with the cervical region and demonstrating how the structural components cooperate during use. The collar body frame is shown circumferentially engaging the anterior and lateral cervical region of the user's neck, conforming to the natural curvature of the neck profile. This circumferential engagement ensures that the apparatus remains securely positioned without shifting during actuation, thereby maintaining fixed spatial relationships among all functional components. The collar body frame acts as the primary load-bearing structure and supports the mounting of resistance module assemblies and the pivot joint at predetermined locations.

Positioned along the lateral side of the collar body frame is a resistance module assembly, identified in the figure as the second resistance module assembly. This module is embedded within a bilateral mounting opening of the collar body frame, although the corresponding opening on the opposite side is not visible in this side view. The resistance module assembly includes an outer housing enclosing the internal spring mechanism, where a compression spring is arranged along a central guide rod between an upper spring seat and a lower spring seat. The figure also shows a preload adjustment screw protruding outwardly from the housing, allowing external access for adjusting the initial compression state of the spring. By rotating the preload adjustment screw, the user can control the baseline resistance provided by the spring, thereby tailoring the mechanical response of the apparatus to specific training requirements.

At the front portion of the collar body frame, a front central mounting bracket is depicted, which serves as the anchoring interface for the pivot joint. This bracket is structurally integrated into the collar body frame and maintains a fixed orientation relative to the user's neck. The pivot joint, mounted at this location, defines a transverse rotational axis about which the mouthpiece arm assembly operates. Because the pivot joint is fixed relative to the collar body frame, the rotational motion generated during use is consistent and repeatable, ensuring that the subsequent conversion of motion into axial displacement occurs along a defined path.

Extending forward from the pivot joint is the mouthpiece arm assembly, which is shown projecting outward from the front of the collar body frame toward the user's mouth. The mouthpiece arm assembly includes an outer arm housing that encloses internal structural elements such as the reinforcement rib and the force transmission rod. The distal end of the arm assembly is fitted with a detachable mouthpiece interface, which is positioned within the oral cavity of the user during operation. The mouthpiece interface is rigidly connected to the arm assembly, forming a continuous mechanical linkage through which force applied by the user is transmitted into the system.

The figure illustrates the functional interaction between the user and the apparatus, wherein force applied at the detachable mouthpiece interface produces rotation of the mouthpiece arm assembly about the pivot joint. The curved directional arrow shown adjacent to the collar body frame indicates the circumferential engagement and stability of the device, while also implying the dynamic nature of the movement during use. As the mouthpiece arm assembly rotates, the internal force transmission rod translates this rotational motion into axial displacement, which is directed toward the resistance module assemblies. This displacement results in compression of the springs within the resistance modules, thereby generating resistance that opposes the applied force.

The alignment of the mouthpiece arm assembly relative to the collar body frame ensures that the direction of applied force remains consistent with the longitudinal axis of the force transmission rod. This alignment is critical for maintaining efficient force transfer and preventing the introduction of lateral or off-axis forces that could reduce effectiveness or cause discomfort. The rigid construction of the arm assembly and its fixed angular relationship with the mouthpiece interface ensure that the applied force is transmitted directly and without loss.

Additionally, the figure highlights that the bilateral mounting openings, although not visible in this side view, are positioned symmetrically on the collar body frame to support both resistance module assemblies. This symmetrical arrangement enables balanced operation when both modules are engaged simultaneously, ensuring that the compression of springs occurs in a coordinated manner when the force transmission rod is actuated. FIG. 4 provides a clear depiction of the apparatus in use, demonstrating how the collar body frame stabilizes the device on the user's neck, how the resistance module assembly is integrated into the structure, and how the mouthpiece arm assembly interacts with the pivot joint to convert user-applied force into controlled mechanical resistance.

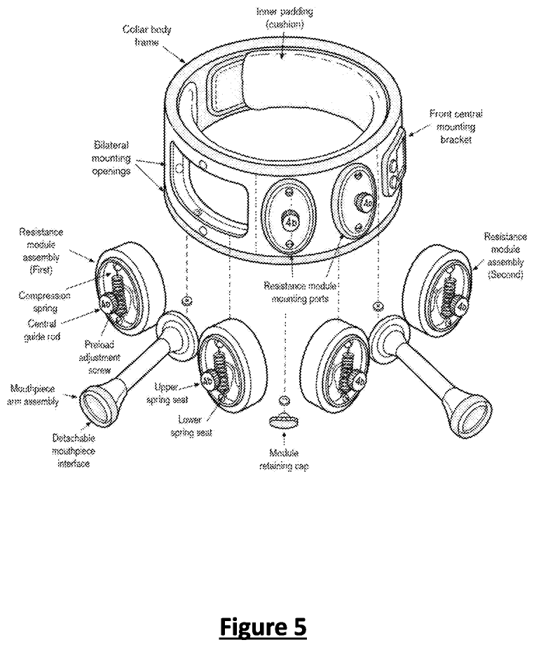

FIG. 5 illustrates an exploded perspective view of the wearable throat muscle training apparatus, clearly depicting the individual components, their relative positioning, and the manner in which they are assembled to form the integrated device in in accordance with an embodiment of the invention. The collar body frame is shown as the primary structural element, forming a continuous annular body configured to encircle the anterior and lateral cervical region of a user. The inner surface of the collar body frame is provided with inner padding, identified as a cushion, which is adapted to conform to the contour of the user's neck and distribute contact pressure uniformly during use. This padding enhances comfort while also stabilizing the device to prevent relative movement between the collar body frame and the user's skin.

Formed along the lateral portions of the collar body frame are bilateral mounting openings, which are configured as structural cutouts or recesses designed to receive the resistance module assemblies. These mounting openings define resistance module mounting ports, which include fastening interfaces such as threaded holes or alignment features that ensure precise positioning of the resistance modules relative to the collar body frame. The figure shows these mounting ports aligned symmetrically about the vertical midline of the collar, thereby ensuring balanced placement of the resistance modules on opposite sides.

The resistance module assemblies are depicted in a separated state, illustrating their internal components prior to assembly. Each resistance module assembly includes an outer housing that encloses a compression spring arranged concentrically around a central guide rod. The central guide rod extends through the compression spring and through aligned bores in the upper spring seat and the lower spring seat. The upper spring seat and lower spring seat are positioned at opposite ends of the compression spring and are configured with planar contact surfaces that engage the end coils of the spring. The central guide rod ensures that the spring seats move along a controlled linear path during compression and decompression, maintaining concentric alignment of the spring within the housing.

Each resistance module assembly further includes a preload adjustment screw positioned on the outer face of the housing. The preload adjustment screw is aligned with the central guide rod and is configured to apply compressive preload directly to the upper spring seat. By rotating the preload adjustment screw, the user can vary the initial compression state of the spring, thereby adjusting the resistance level provided by the module. The figure shows the preload adjustment screw integrated into each resistance module, indicating that both modules can be independently adjusted.

Below the mounting ports, a module retaining cap is shown, which functions as a securing element for fixing the resistance module assemblies within the collar body frame. The retaining cap is aligned with the mounting ports and is configured to engage with corresponding fastening elements, such as screws or threaded inserts, to lock the resistance modules in place. This ensures that once assembled, the resistance modules remain securely positioned within the collar body frame and do not shift during operation.

Also illustrated in the figure are the mouthpiece arm assemblies, each comprising an outer arm housing and a detachable mouthpiece interface at the distal end. The mouthpiece interface is configured to be placed within the oral cavity of the user and is removably attached to the arm assembly to allow for cleaning or replacement. The mouthpiece arm assembly includes an internal force transmission rod (not fully visible in the exploded view but structurally implied), which is configured to translate axial displacement into compressive force applied to the resistance modules. The proximal end of each mouthpiece arm assembly is designed to interface with the central mounting region of the collar body frame through a pivot joint (not fully shown in this figure but indicated by the mounting structure), enabling rotational movement of the arm assembly.

During assembly, each resistance module assembly is inserted into a corresponding mounting opening of the collar body frame, aligned with the resistance module mounting ports, and secured using the module retaining cap and associated fasteners. The mouthpiece arm assembly is then coupled to the front central mounting bracket of the collar body frame, establishing the pivot connection that allows rotational motion. Once assembled, the force transmission rod within the mouthpiece arm assembly engages the upper spring seats of the resistance modules, enabling simultaneous compression of the springs when force is applied through the mouthpiece interface. The exploded configuration shown in FIG. 5 provides a clear understanding of how the individual components are arranged and interconnected to form a cohesive mechanical system. It highlights the modular nature of the resistance assemblies, the alignment features that ensure precise positioning, and the integration of the mouthpiece arm assembly with the collar body frame.

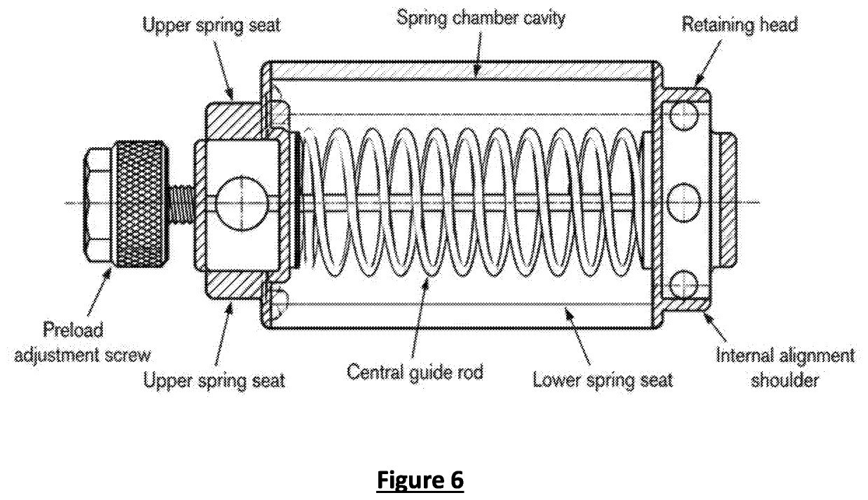

FIG. 6 illustrates a sectional view of an individual resistance module assembly, showing the internal arrangement and interaction of components responsible for generating controlled resistance within the wearable throat muscle training apparatus. The outer housing of the resistance module defines a spring chamber cavity extending along a longitudinal axis, within which a compression spring is positioned. This spring chamber cavity provides a confined and protected environment that maintains the alignment and operational stability of the internal components during repeated compression and decompression cycles.

At one end of the assembly, a preload adjustment screw is shown threadedly engaged with a corresponding threaded interface formed in the outer housing. The preload adjustment screw includes a distal contact surface that directly engages an upper spring seat positioned adjacent to the opening of the spring chamber cavity. The upper spring seat is configured as a movable element that translates along the longitudinal axis in response to adjustment of the preload screw and during operation. When the preload adjustment screw is rotated, it advances or retracts along the threaded interface, thereby producing linear displacement of the distal contact surface. This displacement alters the position of the upper spring seat and imposes an initial compression on the compression spring, thereby establishing a predetermined preload condition that defines the baseline resistance of the module.

The compression spring is arranged concentrically within the spring chamber cavity and is supported at its ends by the upper spring seat and a lower spring seat. The lower spring seat is positioned at the opposite end of the spring chamber cavity and serves as a stable reaction surface for the spring during compression. Both the upper and lower spring seats are configured with planar contact surfaces oriented perpendicular to the longitudinal axis, ensuring that the end coils of the compression spring remain in full-surface engagement during operation. This configuration allows the spring to compress uniformly along its axis without tilting or uneven deformation.

A central guide rod extends axially through the entire length of the compression spring and passes through aligned central bores formed in both the upper spring seat and the lower spring seat. The central guide rod functions as a guiding and stabilizing element that maintains concentric alignment of the compression spring within the spring chamber cavity. By constraining the movement of the spring seats to a linear path along the guide rod, the system prevents lateral displacement or buckling of the spring during repeated compression cycles. The guide rod ensures that the spring deforms symmetrically, thereby preserving consistent resistance characteristics and minimizing wear.

At the opposite end of the assembly, the central guide rod terminates in a retaining head, which is dimensioned to engage an internal alignment shoulder formed within the outer housing. The internal alignment shoulder is positioned at a predetermined location within the housing and serves as a mechanical stop that limits the axial movement of the central guide rod. When the compression spring is subjected to increasing load and approaches its maximum allowable compression, the retaining head comes into contact with the internal alignment shoulder, thereby preventing further displacement. This interaction ensures that the spring does not reach a coil-to-coil contact condition, which could otherwise result in excessive stress or permanent deformation of the spring.

During operation, when an external force is applied through the force transmission rod (not shown in this figure but associated with the upper spring seat), the upper spring seat is driven inward along the central guide rod, compressing the spring between the upper and lower spring seats. The compression occurs in a controlled and concentric manner due to the guiding action of the central guide rod. Upon release of the applied force, the stored elastic energy within the compression spring causes it to expand, thereby pushing the upper spring seat back toward its initial position as defined by the preload adjustment screw.

The sectional view clearly demonstrates that all components are aligned along a common longitudinal axis, including the preload adjustment screw, the upper spring seat, the compression spring, the central guide rod, and the lower spring seat. This coaxial arrangement ensures that forces are transmitted directly along the axis of the spring, eliminating angular deviation and enabling efficient force transfer. The absence of intermediate linkages between the preload adjustment screw and the upper spring seat further ensures that adjustments are directly translated into changes in spring compression without loss of precision.

FIG. 6 provides a detailed representation of the internal working of the resistance module assembly, highlighting how the preload adjustment mechanism, guided spring compression system, and travel-limiting features interact to produce a controlled, stable, and repeatable resistance response.

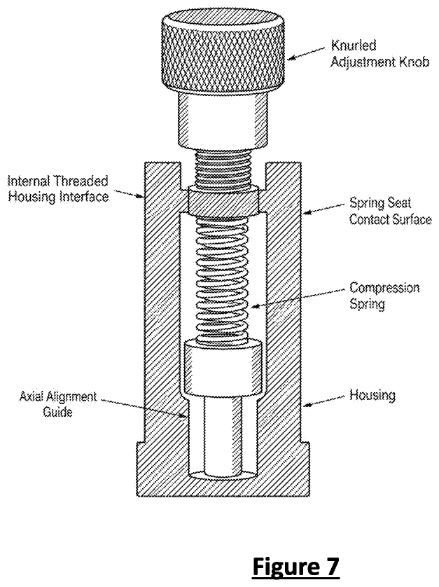

FIG. 7 illustrates a detailed sectional view of the preload adjustment mechanism integrated within the resistance module assembly, highlighting the structural configuration and functional interaction of the knurled adjustment knob, threaded interface, spring seat contact surface, compression spring, axial alignment guide, and housing. The housing is depicted as a rigid enclosure defining an internal cavity that accommodates the compression spring and associated guiding components. This housing forms the structural boundary within which all internal elements are aligned and constrained, ensuring that movement occurs strictly along a defined longitudinal axis.

At the upper portion of the assembly, a knurled adjustment knob is provided, which is integrally connected to a threaded shaft forming part of the preload adjustment screw. The knurled surface of the adjustment knob enhances manual grip, allowing a user to apply rotational input with precision and control. The threaded shaft extends downward from the knob and engages with an internal threaded housing interface formed within the upper region of the housing. This threaded engagement converts rotational motion of the knob into linear displacement of the threaded shaft along the longitudinal axis. The pitch of the threads determines the rate of axial movement per unit of rotation, enabling fine and controlled adjustment of the preload condition.

The lower end of the threaded shaft terminates in a spring seat contact surface, which is configured to directly engage the upper end of the compression spring or the upper spring seat associated with the spring. This contact surface is oriented perpendicular to the longitudinal axis, ensuring that any force applied through the adjustment screw is transmitted centrally and uniformly into the compression spring. As the adjustment knob is rotated in a tightening direction, the threaded shaft advances downward, causing the contact surface to move closer to the compression spring and exert a compressive force. This results in a reduction of the free length of the spring and establishes an initial compression state, thereby increasing the resistance that the spring will provide during operation.

The compression spring is positioned within the housing beneath the spring seat contact surface and extends along the central axis of the assembly. The spring is supported at its lower end by a component aligned with an axial alignment guide, which ensures that the spring remains concentrically positioned within the housing during compression and decompression. The axial alignment guide is depicted as a cylindrical feature extending along the lower portion of the housing, providing a sliding interface that constrains the movement of the lower spring support element. This guide prevents lateral displacement or tilting of the spring, thereby maintaining uniform deformation and consistent force characteristics throughout repeated cycles.

As the preload adjustment screw is rotated, the linear displacement of the spring seat contact surface compresses the spring incrementally. Each incremental rotation of the knurled adjustment knob results in a corresponding and predictable axial movement due to the threaded engagement, allowing precise control over the magnitude of preload applied to the spring. For example, a partial rotation of the knob produces a small displacement, enabling fine tuning of resistance, while multiple rotations can significantly increase the preload, thereby adjusting the device for higher resistance requirements.

The coaxial arrangement of the knurled adjustment knob, threaded shaft, spring seat contact surface, compression spring, and axial alignment guide ensures that all forces are transmitted along a common axis. This alignment eliminates angular deviation and prevents uneven loading of the spring, which could otherwise lead to inconsistent performance or premature wear. The direct interaction between the threaded shaft and the spring seat contact surface further ensures that the applied preload is transferred efficiently without intermediate components, thereby enhancing responsiveness and accuracy of adjustment.

During operation of the apparatus, the preload established by this mechanism defines the initial resistance that must be overcome when force is applied through the mouthpiece interface. As the user actuates the device, the compression spring undergoes additional compression beyond the preload state, and upon release, the spring expands to return to the position defined by the preload setting. The stability of the threaded engagement ensures that the preload remains constant over multiple cycles, maintaining consistent performance without unintended variation.

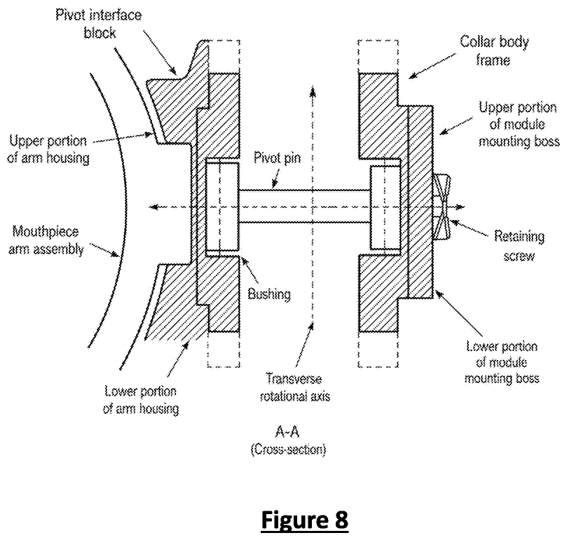

FIG. 8 illustrates a cross-sectional view taken along section A-A of the pivot joint assembly, depicting the structural interface between the mouthpiece arm assembly and the collar body frame and showing how rotational motion is enabled and constrained about a defined transverse axis. The collar body frame is shown on one side as a rigid structural element incorporating an upper portion and a lower portion of a module mounting boss, which together define a mounting region for receiving and supporting the pivot joint components. These portions of the module mounting boss are integrally formed with the collar body frame and provide a fixed anchoring structure that maintains the position of the pivot pin relative to the device geometry.

Extending across the mounting region is the pivot pin, which defines the transverse rotational axis about which the mouthpiece arm assembly rotates. The pivot pin is oriented perpendicular to the longitudinal axis of the force transmission rod and is fixed relative to the collar body frame through engagement with the module mounting boss and a retaining screw positioned at one end. The retaining screw secures the pivot pin in place, preventing axial movement of the pin while allowing rotational movement of the connected components. This fixed positioning ensures that the pivot pin serves as a stable and non-translating axis during operation.

On the opposite side of the pivot pin, the mouthpiece arm assembly is shown, including an upper portion and a lower portion of the arm housing that together form a structural enclosure around the pivot interface block. The pivot interface block is positioned within the arm housing and is configured to rotate about the pivot pin. A bushing is provided between the pivot pin and the pivot interface block, serving as a low-friction interface that facilitates smooth rotational movement while minimizing wear. The bushing also ensures proper alignment between the rotating and stationary components, maintaining concentricity and reducing mechanical play during repeated cycles of operation.

The pivot interface block is rigidly connected to the mouthpiece arm assembly, such that any rotational movement of the arm assembly is directly transmitted to the pivot interface block. As the user applies force through the mouthpiece interface (not shown in this figure but connected to the arm assembly), the mouthpiece arm assembly rotates about the pivot pin, and this rotation occurs around the transverse rotational axis defined by the pivot pin. The dashed lines in the figure indicate the axis of rotation and the alignment of the pivot components relative to the surrounding structures.

The configuration of the pivot joint ensures that rotational motion is confined strictly to the interface between the pivot interface block and the pivot pin, while all other components remain fixed relative to the collar body frame. The upper and lower portions of the arm housing enclose the pivot interface block and maintain its alignment with the pivot pin, preventing lateral displacement or misalignment during operation. This enclosure also protects the pivot components from external contaminants and mechanical damage.

The arrangement of the pivot joint is such that the rotational movement of the mouthpiece arm assembly is consistently converted into linear displacement of the force transmission rod through the offset relationship between the pivot axis and the rod axis, as defined in the broader system. The fixed orientation of the pivot pin relative to the collar body frame ensures that this conversion remains consistent across all actuation cycles, providing predictable and repeatable motion characteristics.

Additionally, the structural integration of the pivot joint within the collar body frame and the arm housing ensures that the mechanical loads generated during operation are distributed evenly across the supporting structures. The module mounting boss provides a robust support for the pivot pin, while the arm housing distributes the forces applied through the mouthpiece interface, thereby maintaining stability and preventing deformation.

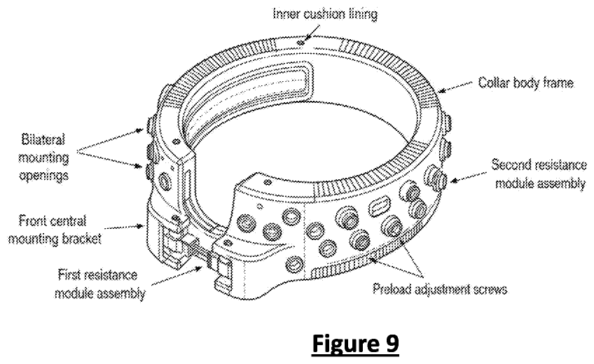

FIG. 9 illustrates a perspective view of the wearable throat muscle training apparatus, emphasizing the external structural configuration of the collar body frame, the arrangement of resistance module assemblies, and the accessibility of adjustment and mounting features in accordance with an embodiment of the invention. The collar body frame is depicted as a continuous annular structure designed to encircle the anterior and lateral cervical region of a user, with its geometry shaped to conform to the natural curvature of the neck. The inner surface of the collar body frame is provided with an inner cushion lining, which is integrated along the circumferential interior surface to enhance user comfort and to ensure uniform distribution of contact forces when the apparatus is worn. This inner lining also contributes to stabilizing the device against the neck, preventing displacement during operation.

Formed along the outer periphery of the collar body frame are bilateral mounting openings, which are positioned symmetrically about a vertical midline. These openings serve as fixed interfaces for receiving the resistance module assemblies and are dimensioned to ensure precise alignment of the modules relative to the collar body frame. The bilateral positioning ensures that the resistance modules are arranged on opposite sides of the collar, thereby enabling balanced mechanical interaction during actuation. The figure shows these mounting openings as recessed regions or cutouts within the collar body frame, indicating their role in accommodating the structural integration of the resistance modules.

At the front region of the collar body frame, a front central mounting bracket is clearly illustrated. This bracket forms a protruding structural feature that serves as the attachment point for the pivot joint associated with the mouthpiece arm assembly. The front central mounting bracket is rigidly integrated into the collar body frame, ensuring that the pivot axis remains fixed relative to the structure of the device. This fixed positioning is critical for maintaining consistent conversion of rotational motion into axial displacement during operation.

The figure further depicts the first resistance module assembly and the second resistance module assembly mounted within the bilateral mounting openings. Each resistance module assembly is housed within an outer casing that is flush-mounted or partially recessed into the collar body frame, ensuring a compact and stable configuration. The resistance modules contain internal components such as compression springs, central guide rods, and spring seats, which are not visible in this external view but are structurally aligned with the mounting openings. The placement of these modules on opposite sides of the collar body frame ensures that forces transmitted through the force transmission rod are distributed symmetrically when preload conditions are identical.

Adjacent to the resistance module assemblies, a series of preload adjustment screws are shown distributed along the outer surface of the collar body frame. These screws are accessible externally and are aligned with the respective resistance modules, allowing the user to adjust the initial compression state of each spring independently. The presence of multiple adjustment screws indicates the capability for fine tuning of resistance levels, enabling the apparatus to be configured for different operational requirements. The external positioning of these screws ensures ease of access for adjustment without requiring disassembly of the device.

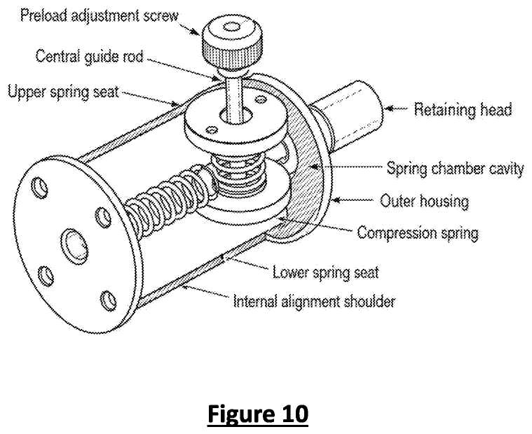

FIG. 10 illustrates a perspective cutaway view of a resistance module assembly, revealing the internal arrangement of components within the outer housing and showing how the preload adjustment mechanism, spring system, and alignment features interact in accordance with an embodiment of the invention. The outer housing is depicted as a cylindrical enclosure defining a spring chamber cavity extending along a longitudinal axis. This housing provides structural containment for the internal components and ensures that all elements remain aligned during operation while also protecting them from external disturbances.

Within the spring chamber cavity, a compression spring is positioned concentrically and extends between an upper spring seat and a lower spring seat. The lower spring seat is located near the base of the housing and provides a stable reaction surface against which the compression spring acts during loading. The upper spring seat is positioned at the opposite end of the spring and is configured to translate along the longitudinal axis in response to applied forces. Both the upper and lower spring seats are formed with planar contact surfaces oriented perpendicular to the axis of the spring, ensuring uniform engagement with the end coils of the compression spring and enabling even distribution of compressive forces.

A central guide rod extends axially through the compression spring and passes through aligned central bores formed in the upper spring seat and the lower spring seat. This central guide rod functions as a guiding element that maintains concentric alignment of the compression spring and constrains the motion of the spring seats to a linear path. The guide rod prevents lateral displacement or buckling of the spring during repeated compression cycles, thereby ensuring consistent deformation and reliable resistance characteristics.

At the upper end of the assembly, a preload adjustment screw is shown positioned above the upper spring seat. The preload adjustment screw includes a threaded shaft that engages with a corresponding threaded interface within the outer housing, allowing rotational input to be converted into linear displacement. The distal end of the preload adjustment screw is aligned with the central guide rod and is configured to apply compressive force directly to the upper spring seat. By rotating the preload adjustment screw, the user can advance the screw into the housing, thereby pushing the upper spring seat downward and compressing the spring to establish an initial preload condition. This preload defines the baseline resistance level of the module and can be adjusted incrementally based on user requirements.

At the opposite end of the central guide rod, a retaining head is provided, which extends outwardly beyond the outer housing. The retaining head is dimensioned to engage an internal alignment shoulder formed within the housing. The internal alignment shoulder is located within the spring chamber cavity and serves as a mechanical stop that limits the axial movement of the central guide rod. When the compression spring is subjected to increasing load and approaches its maximum allowable compression, the retaining head comes into contact with the internal alignment shoulder, thereby preventing further displacement and avoiding coil-to-coil contact within the spring.

The internal alignment shoulder is also shown as an annular feature within the housing that defines the boundary of the permissible travel range for the guide rod. This feature ensures that the compression spring operates within a controlled displacement range, maintaining its structural integrity and preventing over-compression.

During operation, when force is transmitted to the upper spring seat through the force transmission rod (not shown in this figure but associated with the upper spring seat), the upper spring seat moves along the central guide rod, compressing the spring against the lower spring seat. The central guide rod ensures that this movement remains aligned with the longitudinal axis, while the preload adjustment screw defines the initial position from which compression begins. Upon release of the applied force, the compression spring expands, pushing the upper spring seat back toward its initial position, with the motion constrained by the preload setting and the travel limit defined by the retaining head and internal alignment shoulder.

The cutaway perspective in FIG. 10 provides a clear visualization of the coaxial arrangement of all critical components, including the preload adjustment screw, central guide rod, compression spring, and spring seats. This alignment ensures that forces are transmitted directly along the axis of the spring, eliminating angular deviation and enabling efficient and predictable operation. The absence of intermediate linkage elements between the preload adjustment screw and the upper spring seat further enhances the precision of preload adjustment and ensures immediate response to rotational input.

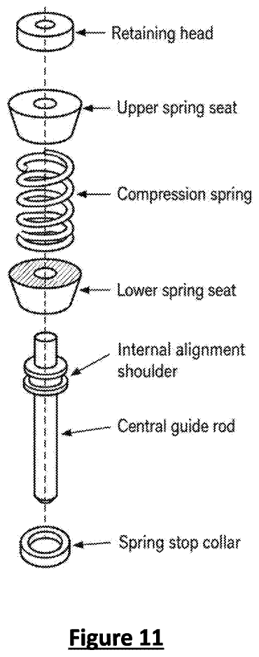

FIG. 11 illustrates an exploded, component-level view of the internal elements of a resistance module assembly, arranged along a common longitudinal axis to clearly demonstrate the structural hierarchy, alignment relationships, and assembly sequence in accordance with an embodiment of the invention. At the top of the figure, a retaining head is shown as a terminal element associated with the central guide rod, configured to function as a travel-limiting interface. The retaining head is dimensioned to engage with a corresponding internal alignment shoulder within the housing (not shown in this exploded view), thereby defining an upper bound of permissible axial displacement during operation and preventing excessive compression of the spring.

Immediately below the retaining head is the upper spring seat, which is configured as a load-transmitting component positioned at the upper end of the compression spring. The upper spring seat includes a central bore through which the central guide rod passes, ensuring that its movement is constrained along the longitudinal axis. The geometry of the upper spring seat is such that its lower surface provides a planar contact interface with the uppermost coil of the compression spring, thereby distributing applied forces uniformly across the spring during compression. This component is also the primary interface through which force from the force transmission rod is introduced into the spring system.

Positioned beneath the upper spring seat is the compression spring itself, depicted as a helical element aligned concentrically along the central axis. The compression spring is designed to deform elastically under axial load, storing mechanical energy during compression and releasing it during decompression. Its placement between the upper and lower spring seats ensures that it operates within a guided and constrained environment, maintaining consistent alignment and preventing lateral buckling.

Below the compression spring, the lower spring seat is shown, which serves as a fixed or guided support for the lower end of the spring. Similar to the upper spring seat, the lower spring seat includes a central bore aligned with the central guide rod and provides a planar contact surface for the bottom coil of the compression spring. The lower spring seat ensures that the spring is supported evenly during compression and that the applied load is transmitted uniformly through the spring structure.

Extending downward from the lower spring seat is the central guide rod, which is depicted as a linear cylindrical element passing through the central bores of both spring seats and the compression spring. The central guide rod functions as a primary alignment feature, ensuring that all components remain coaxially aligned during operation. The guide rod prevents lateral displacement and maintains concentric deformation of the compression spring, thereby enabling consistent mechanical behavior over repeated cycles. Along the guide rod, an internal alignment shoulder is shown as an annular feature positioned at a specific location along its length. This shoulder is designed to interact with the retaining head (when assembled within the housing) to define a bounded axial travel range, ensuring that the spring does not reach a coil-stacking condition.

At the lower end of the central guide rod, a spring stop collar is depicted, which serves as a positioning and retention element for the guide rod within the assembly. The spring stop collar is configured to engage with a corresponding feature in the housing or to provide a seating interface that maintains the axial position of the guide rod. This component ensures that the guide rod remains properly positioned relative to the lower spring seat and prevents unintended axial movement of the rod during operation.

The exploded arrangement shown in FIG. 11 clearly illustrates that all components are aligned along a single central axis, enabling a direct and uninterrupted load path from the upper spring seat through the compression spring to the lower spring seat and into the supporting structure. During assembly, the central guide rod is first positioned with the spring stop collar, followed by placement of the lower spring seat, the compression spring, and the upper spring seat, with the retaining head completing the assembly at the upper end. Once enclosed within the outer housing, the interaction between the retaining head and the internal alignment shoulder defines the maximum allowable displacement, while the spring seats and guide rod ensure controlled and concentric compression.

In operation, force applied to the upper spring seat is transmitted through the compression spring to the lower spring seat, with the central guide rod maintaining alignment and preventing deviation. Upon release of the applied force, the stored elastic energy within the spring drives the upper spring seat back toward its initial position.

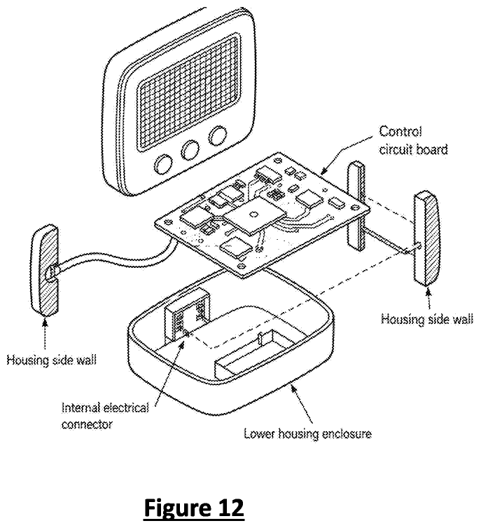

FIG. 12 illustrates an exploded perspective view of an electronic control and interface module integrated within the wearable throat muscle training apparatus, showing the structural arrangement of a display unit, control circuit board, housing side walls, internal electrical connector, and lower housing enclosure. The figure depicts how electronic components are physically organized and mechanically supported within a compact enclosure to provide monitoring, feedback, or control functionality associated with the apparatus.

At the upper portion of the figure, a display unit is shown, which includes a front-facing interface having a visual display region and user-operable input elements such as buttons. The display unit is configured to present operational parameters, such as resistance levels, usage metrics, or system status, and may also receive user inputs for adjusting settings. The display unit is structurally supported above the control circuit board and is positioned such that it is externally visible when the device is assembled, enabling direct interaction by the user.

Below the display unit, a control circuit board is illustrated, which serves as the central processing and control element of the electronic module. The control circuit board includes multiple electronic components mounted on its surface, such as processing units, signal conditioning elements, and interface circuitry. These components are interconnected through conductive traces formed on the board, enabling the processing of electrical signals received from various parts of the apparatus. The control circuit board is dimensioned to fit within the housing and is supported by structural features that maintain its position relative to the enclosure.

On either side of the control circuit board, housing side walls are shown, which form part of the enclosure that protects and supports the electronic components. These side walls are configured to align with corresponding features on the lower housing enclosure and provide lateral support to the control circuit board. The dashed lines indicate the positioning and alignment of the side walls relative to the circuit board and the enclosure, ensuring that the board is held securely in place when the assembly is completed.

At the lower portion of the figure, a lower housing enclosure is depicted, which forms the base of the electronic module. This enclosure defines an internal cavity that accommodates the control circuit board and associated components. Within this cavity, an internal electrical connector is provided, which serves as an interface for connecting the control circuit board to other electrical or electromechanical components of the apparatus. The internal electrical connector may be configured to receive power input, sensor signals, or to transmit control signals to other modules within the system.

The assembly process illustrated in FIG. 12 involves positioning the control circuit board within the lower housing enclosure, aligning it with the internal electrical connector, and securing it using the housing side walls. The display unit is then mounted above the control circuit board, forming a complete electronic module that is enclosed within the housing structure. The alignment of all components ensures that electrical connections are maintained and that the module operates reliably under mechanical loading conditions associated with use of the apparatus.

The integration of this electronic module within the device enables additional functionality beyond the purely mechanical operation of the resistance modules. For example, the control circuit board may be configured to receive input signals indicative of displacement, force, or usage cycles, process these signals, and display corresponding information on the display unit. The electronic module may also facilitate user-controlled adjustment of operational parameters or provide feedback to enhance training effectiveness.

The structural configuration shown in FIG. 12 ensures that all electronic components are securely housed, properly aligned, and protected from external influences such as mechanical stress or environmental exposure. The arrangement of the housing side walls and the lower housing enclosure provides mechanical stability, while the internal electrical connector ensures reliable signal transmission between the control circuit board and other parts of the apparatus.

FIG. 12 demonstrates the integration of an electronic control and display system within the wearable throat muscle training apparatus, illustrating how electronic and mechanical components are combined to provide enhanced functionality while maintaining structural integrity and alignment consistent with the requirements of the invention.

The present disclosure relates to a wearable throat muscle training apparatus configured as a fully mechanical system in which controlled resistance is generated, transmitted, and regulated through a sequence of structurally constrained interactions among interconnected components. The operation of the apparatus follows a deterministic mechanical sequence, hereinafter described as an operational technique, wherein each stage of motion and force transfer is governed by fixed geometric relationships, guided interfaces, and calibrated resistance elements. This technique is embodied entirely in the physical configuration of the device and is executed through user-induced actuation without reliance on electronic control systems.

In an initial state of operation, the collar body frame is positioned circumferentially around the anterior and lateral cervical region of a user such that the bilateral mounting openings are symmetrically aligned relative to the vertical midline of the neck. The collar body frame establishes a fixed reference structure that maintains spatial relationships among all operative components, including the resistance module assemblies and the pivot joint. Each resistance module assembly is secured within a corresponding mounting opening, thereby fixing the orientation of the spring chamber cavity and the central guide rod along a predefined longitudinal axis relative to the collar body frame.

Prior to actuation, an initialization step is performed through adjustment of preload conditions within each resistance module assembly. This is achieved by rotational advancement of the preload adjustment screw within the threaded interface of the outer housing. As the preload adjustment screw advances along its axis, the distal contact surface engages the upper spring seat and imposes an initial compressive displacement on the compression spring. This establishes a baseline resistance state defined by a predetermined spring compression level. The preload adjustment screws of the respective resistance module assemblies may be independently set to establish either symmetric or asymmetric resistance profiles, depending on the intended training configuration.

Following initialization, the detachable mouthpiece interface is positioned within the oral cavity of the user, forming a rigid mechanical linkage with the force transmission rod through the mouthpiece arm assembly. The mouthpiece arm assembly is coupled to the collar body frame through a pivot joint comprising a pivot interface block and a pivot pin. The pivot pin defines a fixed transverse rotational axis relative to the collar body frame, and the mouthpiece arm assembly is constrained to rotate about this axis.

Upon application of force by the user against the detachable mouthpiece interface, a rotational input is generated about the pivot pin. Due to the fixed radial offset between the pivot axis and the longitudinal axis of the force transmission rod, this rotational input is converted into a linear displacement through a lever mechanism. The magnitude of the linear displacement is directly proportional to the angular displacement of the mouthpiece arm assembly and the defined offset distance, thereby establishing a predictable relationship between applied force and resulting motion.

The force transmission rod, positioned within the outer arm housing, is constrained by guiding surfaces formed by the internal reinforcement rib. These guiding surfaces maintain the rod in a strictly axial path, preventing lateral displacement and rotational deviation during movement. As the mouthpiece arm assembly rotates, the force transmission rod undergoes axial translation along its longitudinal axis, which is aligned centrally between the first resistance module assembly and the second resistance module assembly.

At the proximal end of the force transmission rod, the bifurcated engagement portion simultaneously interfaces with the upper spring seats of both resistance module assemblies. Each engagement arm of the bifurcated portion maintains planar contact with the corresponding upper spring seat, ensuring continuous and direct transfer of force. The lateral spacing between the engagement arms corresponds precisely to the spacing between the resistance module assemblies, thereby maintaining synchronized engagement throughout the actuation cycle.

As the force transmission rod advances axially, the engagement arms apply compressive force to the upper spring seats, causing them to translate along the central guide rods within the respective spring chamber cavities. The central guide rods maintain concentric alignment of the compression springs and constrain the motion of the upper and lower spring seats to a linear path. This ensures that the compression springs deform uniformly along their longitudinal axes without buckling or lateral displacement.

During the compression phase, the compression springs store mechanical energy in the form of elastic deformation. The extent of compression is governed by the magnitude of the applied force, the initial preload condition, and the stiffness characteristics of the springs. The central guide rod is retained within the outer housing by engagement between the retaining head and the internal alignment shoulder, which together define a maximum permissible travel range. This arrangement prevents excessive compression and ensures that the spring does not reach a coil-stacking condition during normal operation.

Throughout the actuation process, the mechanical load is transmitted along a continuous path extending from the detachable mouthpiece interface, through the mouthpiece arm assembly, into the force transmission rod, and subsequently into the compression springs via the upper spring seats. The absence of intermediate flexible elements or discontinuities ensures that the applied force is transferred efficiently and without attenuation.

Upon reduction or release of the applied force at the detachable mouthpiece interface, the stored elastic energy within the compression springs initiates a return phase of the operational technique. The compression springs expand along the central guide rods, driving the upper spring seats back toward their initial positions defined by the preload adjustment screws. This expansion generates a reverse axial displacement of the force transmission rod, which in turn produces a corresponding rotational return of the mouthpiece arm assembly about the pivot pin.

During the return phase, continuous contact is maintained between the engagement arms and the upper spring seats, ensuring that the force transmission rod remains engaged throughout the entire cycle. The guiding surfaces of the internal reinforcement rib maintain alignment of the force transmission rod during both forward and return motion, thereby preserving the integrity of the motion path and preventing misalignment.

The operational technique thus comprises a cyclic sequence of initialization, actuation, compression, energy storage, release, and return, all governed by the fixed mechanical configuration of the apparatus. The collar body frame ensures that all components remain in predetermined spatial relationships, enabling consistent and repeatable execution of the technique across multiple cycles. When preload conditions are identical in both resistance module assemblies, the system produces symmetrical compression and balanced muscle engagement. Conversely, when preload conditions differ, the system generates controlled asymmetry in resistance, allowing targeted training of specific muscle groups.

The mechanical arrangement ensures that each stage of the operational technique is executed through direct physical interaction among components, with motion constrained along defined axes and force transmitted through continuous structural interfaces. This results in a predictable and repeatable resistance profile that is inherently determined by the geometry, material properties, and configuration of the device.

The wearable throat muscle training apparatus comprises a collar body frame configured to circumferentially engage the anterior and lateral cervical region of a user. The collar body frame is formed as a rigid structural loop maintaining fixed spatial positioning relative to the user's neck and includes bilateral mounting openings positioned symmetrically about a vertical midline. These mounting openings serve as fixed interfaces for receiving resistance module assemblies while maintaining precise alignment relative to the collar geometry. A front central mounting bracket is integrally formed with the collar body frame and provides a structural interface for a pivot joint assembly.

Each resistance module assembly is rigidly secured within a corresponding mounting opening and comprises an outer housing defining a spring chamber cavity extending along a longitudinal axis. Within the spring chamber cavity, a compression spring is positioned concentrically around a central guide rod. The central guide rod extends through aligned central bores of an upper spring seat and a lower spring seat, maintaining axial alignment of the compression spring during operation. The central guide rod is retained within the outer housing by engagement between a retaining head and an internal alignment shoulder, thereby defining a bounded axial travel range that prevents excessive displacement and structural instability.

The upper spring seat and lower spring seat are configured to translate along the central guide rod while maintaining planar contact with the end coils of the compression spring. A preload adjustment screw is threadedly engaged with a threaded interface formed in the outer housing and is aligned coaxially with the central guide rod. The preload adjustment screw includes a distal contact surface configured to engage the upper spring seat, such that rotational advancement of the screw produces linear displacement and establishes an initial compression state of the compression spring. Independent adjustability of the preload screws in each resistance module enables asymmetric resistance configuration where required.

The front central mounting bracket supports a pivot joint comprising a pivot interface block and a pivot pin extending through aligned bores. The pivot pin defines a fixed transverse rotational axis relative to the collar body frame, while the pivot interface block is fixed relative to a mouthpiece arm assembly. The mouthpiece arm assembly extends forward from the collar body frame and comprises an outer arm housing enclosing an internal reinforcement rib structure.

The internal reinforcement rib extends longitudinally within the arm housing and defines multiple guiding surfaces aligned parallel to the longitudinal axis of a force transmission rod. The force transmission rod is positioned within the arm housing and is constrained by the guiding surfaces to permit only axial movement while preventing lateral displacement and rotational deviation. This ensures precise linear motion during operation.

At a proximal end, the force transmission rod includes a bifurcated engagement portion comprising two engagement arms spaced to align with the upper spring seats of the respective resistance module assemblies. Each engagement arm includes a planar contact interface positioned in direct abutment with the corresponding upper spring seat, ensuring simultaneous and synchronized force transmission.

At a distal end, the force transmission rod is rigidly connected to a detachable mouthpiece interface configured for placement within the oral cavity of the user. The mouthpiece interface forms a rigid extension of the force transmission path, ensuring that applied force is transmitted directly into the mechanical system without loss or deviation.

Upon application of force by the user through the mouthpiece interface, the mouthpiece arm assembly rotates about the pivot pin. Due to the offset between the pivot axis and the longitudinal axis of the force transmission rod, this rotational movement generates a lever-induced linear displacement of the force transmission rod. The axial displacement is transmitted simultaneously through the bifurcated engagement portion to both upper spring seats, resulting in compression of the compression springs along their respective central guide rods.

The compression springs deform elastically within the spring chamber cavities while maintaining concentric alignment due to the guiding action of the central guide rods. The internal alignment shoulder and retaining head prevent excessive travel of the central guide rod, thereby ensuring that compression remains within safe operational limits and preventing coil stacking.

Upon release of the applied force, stored elastic energy within the compression springs produces expansion, which drives the upper spring seats and, correspondingly, the force transmission rod back toward an initial position defined by the preload adjustment screws. Throughout this return motion, continuous engagement is maintained between the engagement arms and the upper spring seats, ensuring uninterrupted mechanical linkage.

The collar body frame maintains fixed spatial relationships between all components, ensuring that displacement of the force transmission rod occurs along a repeatable linear path aligned with the central guide rods. This structural arrangement enables consistent bilateral loading when preload conditions are equal and allows controlled asymmetry when preload settings differ.

The entire apparatus operates through direct mechanical interaction among rigid and elastically deformable components, forming a continuous load path extending from the mouthpiece interface through the mouthpiece arm assembly, force transmission rod, and resistance modules. The configuration ensures precise force alignment, controlled displacement, and repeatable resistance characteristics suitable for targeted throat muscle training.

The disclosed apparatus is applicable in medical rehabilitation, speech therapy, athletic conditioning, and physiotherapy environments where controlled strengthening of throat and cervical muscles is required. The device is suitable for repeated use, offers adjustable resistance levels, and provides consistent mechanical performance due to its structurally constrained and hardware-based configuration.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A wearable throat muscle training apparatus comprising:
a collar body frame configured to circumferentially engage an anterior and lateral cervical region of a user, the collar body frame including bilateral mounting openings positioned symmetrically about a vertical midline and a front central mounting bracket, the bilateral mounting openings defining fixed attachment interfaces maintaining positional alignment relative to the collar body frame;
a first resistance module assembly secured within a first mounting opening and a second resistance module assembly secured within a second mounting opening, each resistance module assembly comprising:
an outer housing fixed to the collar body frame;
a spring chamber cavity defined within the outer housing along a longitudinal axis;
a compression spring positioned within the spring chamber cavity;
a central guide rod extending through the compression spring and through aligned central bores of an upper spring seat and a lower spring seat, the central guide rod being retained within the outer housing by engagement between a retaining head and an internal alignment shoulder positioned within the spring chamber cavity;
the upper spring seat and the lower spring seat being configured to translate along the central guide rod while maintaining planar contact with opposite ends of the compression spring;
a preload adjustment screw threadedly engaged with a threaded interface of the outer housing and aligned coaxially with the central guide rod, the preload adjustment screw including a distal contact surface positioned to engage a central region of the upper spring seat to impose an initial compression state of the compression spring;
a mouthpiece arm assembly coupled to the front central mounting bracket through a pivot joint including a pivot interface block and a pivot pin extending through aligned bores and defining a transverse rotational axis fixed relative to the collar body frame;
the mouthpiece arm assembly comprising:
an outer arm housing;
an internal reinforcement rib extending longitudinally within the outer arm housing and defining guiding surfaces; a force transmission rod extending longitudinally within the outer arm housing and constrained by the guiding surfaces to permit axial movement while restricting lateral and rotational displacement, the force transmission rod including a bifurcated proximal engagement portion having two engagement arms positioned in direct abutment with the upper spring seats of the first resistance module assembly and the second resistance module assembly;
a detachable mouthpiece interface fixed to a distal end of the mouthpiece arm assembly and rigidly connected to the force transmission rod; wherein force applied at the detachable mouthpiece interface produces rotation of the mouthpiece arm assembly about the pivot pin, the rotation generating a moment about the pivot pin and producing axial displacement of the force transmission rod along a longitudinal axis offset from the pivot pin; wherein the axial displacement of the force transmission rod is transmitted simultaneously through the bifurcated proximal engagement portion to the upper spring seats of the first resistance module assembly and the second resistance module assembly to compress the compression springs along the central guide rods within the spring chamber cavities; wherein expansion of the compression springs upon release of the applied force produces return displacement of the force transmission rod toward an initial position defined by the preload adjustment screws, wherein each engagement arm of the bifurcated proximal engagement portion includes a planar contact interface oriented perpendicular to the longitudinal axis of the corresponding central guide rod, the planar contact interface maintaining continuous surface contact with the upper spring seat throughout compression and return movement while the bifurcated proximal engagement portion defines a fixed lateral spacing corresponding to spacing between the first resistance module assembly and the second resistance module assembly to maintain synchronous displacement of both upper spring seats, and wherein the central guide rod of each resistance module assembly extends through the upper spring seat and the lower spring seat and is retained between the retaining head and the internal alignment shoulder such that axial movement of the central guide rod is limited prior to coil-to-coil contact of the compression spring, and wherein the central guide rod maintains concentric alignment of the compression spring within the spring chamber cavity during repeated compression cycles; and wherein the preload adjustment screw includes a threaded shaft and the distal contact surface aligned with the central guide rod, rotation of the preload adjustment screw producing linear translation of the distal contact surface along the longitudinal axis to vary a gap between the distal contact surface and the upper spring seat in a pre-load state and to impose a predetermined compressive displacement on the compression spring; and wherein the preload adjustment screw of the first resistance module assembly and the preload adjustment screw of the second resistance module assembly are independently rotatable to establish distinct initial compression states such that displacement of the force transmission rod produces asymmetric compression responses of the compression springs, and wherein the pivot pin is oriented perpendicular to a plane defined by the bifurcated proximal engagement portion and is fixed relative to the collar body frame, and wherein the pivot interface block is fixed relative to the mouthpiece arm assembly such that rotation is confined to the mouthpiece arm assembly about the pivot pin.

2. The apparatus of claim 1, wherein the longitudinal axis of the force transmission rod is offset from the pivot pin by a fixed radial distance such that rotation of the mouthpiece arm assembly produces linear displacement of the force transmission rod through lever action about the pivot pin, and wherein the internal reinforcement rib includes a plurality of guiding surfaces positioned at spaced intervals along the force transmission rod, the guiding surfaces being aligned parallel to the longitudinal axis and maintaining sliding engagement with the force transmission rod to constrain lateral displacement and torsional rotation, and wherein the force transmission rod is aligned along a central longitudinal axis extending between the first resistance module assembly and the second resistance module assembly and intersecting a midpoint defined by the collar body frame such that axial displacement of the force transmission rod produces equal compression of both compression springs when the preload adjustment screws are set to identical initial compression states.

3. The apparatus of claim 1, wherein the internal alignment shoulder is positioned between the threaded interface and the spring chamber cavity and forms a mechanical stop that engages the retaining head of the central guide rod prior to full compression of the compression spring, and wherein the upper spring seat and the lower spring seat include planar spring-contact surfaces extending perpendicular to the central guide rod and maintaining continuous contact with end coils of the compression spring during compression and decompression; and wherein the force transmission rod is in direct abutment with the upper spring seats without intermediate linkage elements such that axial displacement of the force transmission rod produces immediate compression of the compression springs.

4. The apparatus of claim 1, wherein the detachable mouthpiece interface is rigidly fixed to the distal end of the mouthpiece arm assembly such that force applied within the oral cavity is transmitted along a continuous rigid path through the mouthpiece arm assembly into the force transmission rod, and wherein the mouthpiece arm assembly maintains a fixed angular relationship between the detachable mouthpiece interface and the force transmission rod during rotation about the pivot joint such that direction of applied force remains aligned with the longitudinal axis of the force transmission rod.

5. The apparatus of claim 1, wherein the collar body frame maintains fixed spatial positioning of the first resistance module assembly, the second resistance module assembly, and the pivot joint such that displacement of the force transmission rod follows a repeatable linear path aligned with the central guide rods, and wherein simultaneous compression of the compression springs of the first resistance module assembly and the second resistance module assembly occurs in response to a single continuous displacement of the force transmission rod through the bifurcated proximal engagement portion.

6. The apparatus of claim 1, wherein expansion of the compression springs produces return displacement of the force transmission rod along the longitudinal axis while maintaining engagement between the engagement arms and the upper spring seats, wherein the guiding surfaces of the internal reinforcement rib maintain coaxial alignment between the force transmission rod and the central guide rods during both compression and return motion, wherein the preload adjustment screws define respective initial positions of the upper spring seats such that the compression springs operate within predetermined displacement ranges during actuation; and wherein displacement of the detachable mouthpiece interface produces a continuous mechanical load transfer from the detachable mouthpiece interface through the mouthpiece arm assembly and the force transmission rod into the compression springs along the central guide rods without interruption in the load path.

7. The apparatus of claim 1, wherein the bifurcated proximal engagement portion of the force transmission rod is positioned such that each engagement arm is aligned along a respective longitudinal axis of the central guide rod of the first resistance module assembly and the second resistance module assembly, and wherein the planar contact interface of each engagement arm engages a central region of the corresponding upper spring seat intersecting the central bore, the alignment maintaining collinear force transfer from the force transmission rod into the compression springs during both compression and return motion; and wherein the central guide rod, the preload adjustment screw, and the force transmission rod are arranged along substantially parallel axes, and wherein axial displacement of the force transmission rod is transmitted into the compression spring through the upper spring seat without angular deviation, the arrangement maintaining linear compression of the compression spring within the spring chamber cavity.

8. The apparatus of claim 1, wherein the internal alignment shoulder and the retaining head of the central guide rod define a bounded axial travel range of the central guide rod, the bounded axial travel range being less than a maximum compression length of the compression spring defined by adjacent coil contact, such that engagement between the retaining head and the internal alignment shoulder occurs prior to coil stacking of the compression spring.

9. The apparatus of claim 1, wherein the preload adjustment screw is positioned such that the distal contact surface applies compressive preload directly to the upper spring seat along the longitudinal axis of the central guide rod, and wherein rotation of the preload adjustment screw produces incremental linear displacement of the distal contact surface within the spring chamber cavity corresponding to thread advancement within the threaded interface.

10. The apparatus of claim 1, wherein the pivot joint is configured such that the pivot pin defines a fixed axis relative to the collar body frame and the pivot interface block rotates about the pivot pin, and wherein the mouthpiece arm assembly translates rotational displacement into linear displacement of the force transmission rod through an offset between the pivot pin and the longitudinal axis of the force transmission rod; and wherein the internal reinforcement rib includes a plurality of longitudinally extending guide channels formed within the outer arm housing, the guide channels receiving the force transmission rod in sliding engagement such that axial movement of the force transmission rod is permitted while lateral displacement and rotational movement of the force transmission rod relative to the outer arm housing are restricted.

11. The apparatus of claim 1, wherein the force transmission rod maintains continuous mechanical engagement with the upper spring seats during both compression and decompression of the compression springs, the engagement preventing disengagement of the bifurcated proximal engagement portion from the upper spring seats throughout a full actuation cycle; and wherein the mouthpiece arm assembly maintains a fixed angular relationship between the detachable mouthpiece interface and the force transmission rod such that a direction of applied force at the detachable mouthpiece interface remains aligned with the longitudinal axis of the force transmission rod during rotation about the pivot joint.

12. The apparatus of claim 1, wherein the collar body frame maintains fixed spatial relationships between the first resistance module assembly, the second resistance module assembly, and the pivot joint such that displacement of the force transmission rod occurs along a repeatable linear path aligned with the central guide rods, the repeatable linear path maintaining symmetrical compression of the compression springs when preload conditions are identical; and wherein expansion of the compression springs following release of force applied at the detachable mouthpiece interface produces return displacement of the force transmission rod toward the initial position defined by the preload adjustment screws while maintaining sliding engagement between the force transmission rod and the guiding surfaces of the internal reinforcement rib.
